(19) United States
(12) Patent Application Publication
(10) Pub. No.: US 2014/0365606 A1
(43) Pub. Date: Dec. 11, 2014

(54) INFORMATION PROCESSING APPARATUS, INFORMATION PROCESSING METHOD, AND PROGRAM

(71) Applicant: Sony Corporation, Tokyo (JP)

(72) Inventor: Masato Shimakawa, Kanagawa (JP)

(73) Assignee: Sony Corporation, Tokyo (JP)

(21) Appl. No.: 14/373,968

(22) PCT Filed: Nov. 27, 2012
(86) PCT No.: PCT/JP2012/007588

§ 371 Date: Jul. 23, 2014

(30) Foreign Application Priority Data
Feb. 13, 2012 (JP) 2012-028074

(51) Int. Cl. H04L 29/08

(52) U.S. Cl. CPC H04L 67/10
USPC 709/217

(57) ABSTRACT

[Object] To reduce the system load on the cloud system and handle a huge number of devices.

[Solving Means] An information processing apparatus includes a communication unit and a control unit. The communication unit is capable of, in case of necessity, connecting to any of a first device, a second device, and a constantly connected server, which is constantly connected to the second device via a network, via the network for communication. The control unit is capable of controlling the communication unit to receive, from the first device, data addressed to the second device, to transmit, to the constantly connected server, notification request information for requesting to transmit a notification message for notifying presence of the data to the second device, and to transmit the data to the second device in response to a request from the second device that receives the notification message.

### TECHNICAL FIELD

The present technology relates to an information processing apparatus that is communicable with a plurality of devices via a network.

### BACKGROUND ART

Conventionally, there is a messaging protocol called extensible messaging and presence protocol (XMPP) as a technique for allowing free communication to be performed between devices that cannot directly communicate with each other due to a network address translation (NAT) router or proxy server/fire wall. Specifically, a server using the XMPP is provided in a cloud system and this server intermediates all communication between the devices such that the devices can communicate with each other without being influenced by the NAT router or proxy server/fire wall. Examples of documents relating to the XMPP include Patent Document 1 below.
Patent Document 1: Japanese Patent Application Laid-open No. 2007-318185

### SUMMARY OF INVENTION

### Problem to be Solved by the Invention

However, in the method using the XMPP, a protocol based on an extensible markup language (XML) is used, and hence the server needs to perform complicated processing such as parsing the XML after the server establishes constant connections to all clients. Thus, in this method, the number of clients that can be handled by a single server is insufficient.

In view of the above-mentioned circumstances, it is an object of the present technology to provide an information processing apparatus, an information processing method, and a program, by which the system load on the cloud system can be reduced and a single apparatus can handle a huge number of devices.

### Means for Solving the Problem

In order to achieve the object, an information processing apparatus according to an embodiment of the present technology includes a communication unit and a control unit. The communication unit is capable of, in case of necessity, connecting to any of a first device, a second device, and a constantly connected server, which is constantly connected to the second device via a network, via the network for communication. The control unit is capable of controlling the communication unit to receive, from the first device, data addressed to the second device, to transmit, to the constantly connected server, notification request information for requesting to transmit a notification message for notifying presence of the data to the second device, and to transmit the data to the second device in response to a request from the second device that receives the notification message.

In the present technology, the information processing apparatus is capable of transmitting, when receiving the data addressed to the second device from the first device, the notification message to the second device via the constantly connected server and transmitting the data in response to an access from the second device. Thus, by causing the constantly connected server to maintain the connection with the first device and the second device and notify the presence of the data, the information processing apparatus can reduce its own load. Further, the constantly connected server does not need complicated processing and only a minimum communication buffer is necessary. Therefore, the constantly connected server can connect to an extremely large number of first and second devices. As a result, the number of devices that can be indirectly handled by the single information processing apparatus is significantly increased.

Here, the above-mentioned data includes any types of data, for example, a moving image, a still image, audio, a text, a message, or a program. Although the information processing apparatus is typically a server device, it is not limited thereto and may be any other devices.

The information processing apparatus may further include a storage unit. The second device may communicate with the information processing apparatus and the constantly connected server via a communication relay apparatus. In this case, the control unit may control, if the communication relay apparatus is set to transfer communication from the information processing apparatus to the second device, the storage unit to store information on the transfer setting. Further, the control unit may control the communication unit to directly transmit the notification message to the second device using the stored information, instead of transmitting the notification request information or in addition to transmitting the notification request information.

With this, the information processing apparatus is also capable of directly transmitting, if the communication relay apparatus (router) on a second device side supports a NAT traversal mechanism using a universal plug and play internet gateway device (UPnP IGD) protocol, the notification message to the second device by so-called NAT traversal.

The control unit may control, if a global IP address is assigned to the second device, the communication unit to directly transmit the notification message to the second device instead of transmitting the notification request information or in addition to transmitting the notification request information.

With this, the information processing apparatus is also capable of directly transmitting, if the second device is accessible without the communication relay apparatus, the notification message to the second device.

The information processing apparatus and the constantly connected server may include a plurality of information processing apparatuses and a plurality of constantly connected servers, respectively. In this case, the first device and the second device may be each set to correspond to one of the information processing apparatuses and one of the constantly connected servers using device identification information for uniquely identifying the first device, the second device, the plurality of information processing apparatuses, and the plurality of constantly connected servers such that each of the first device and the second device communicates with one of the information processing apparatuses and one of the constantly connected servers. In this case, the control unit may control, if it is, based on the device identification information, determined that the second device corresponds to another information processing apparatus, the communication unit to transfer the data to the other information processing apparatus.

With this, the plurality of information processing apparatuses and the plurality of constantly connected servers are present, and hence communication of a larger number of devices is supported.

The information processing apparatus may further include a storage unit. In this case, the control unit may create a table in which a corresponding relationship between a value based on a hash value obtained based on a predetermined hash function based on device identification information of each of the first device and the second device and identification information of each of the plurality of information processing apparatuses is defined. Further, the control unit may control the storage unit to store the created table and determine, based on the stored table, another information processing apparatus corresponding to the second device.

Thus, using the table, the information processing apparatus can easily determine the other information processing apparatus corresponding to the second device.

The control unit may create, if user identification information for uniquely identifying a user who owns each of the first device and the second device is set in each of the first device and the second device, the table using the user identification information instead of the device identification information.

With this, even if the devices have different types of identification information, the devices owned by the same user are connected to the same information processing apparatus, and hence communication between the plurality of information processing apparatuses are reduced and the load on the cloud system is reduced.

An information processing apparatus according to another embodiment of the present technology includes a communication unit and a control unit. The communication unit is capable of constantly connecting to a first device and a second device via a network for communication. Further, the communication unit is capable of, in case of necessity, connecting to a mediation server that mediates transmission and reception of data between the first device and the second device via the network for communication. The control unit is capable of controlling the communication unit to receive, when data addressed to the second device that is transmitted from the first device is received by the mediation server, notification request information for requesting to transmit a notification message for notifying presence of the data to the second device, from the mediation server, and to transmit, based on the notification request information, the notification message to the second device.

With this, the information processing apparatus can significantly increase the number of devices that can be indirectly handled by the single mediation server and can reduce the load on the mediation server.

An information processing apparatus according to another embodiment of the present technology includes a communication unit and a control unit. The communication unit is capable of, in case of necessity, connecting to a first server via a network, and capable of constantly connecting to a second server via the network for communication. The control unit is capable of controlling the communication unit to receive, from the second server, a notification message for notifying presence of data transmitted from another information processing apparatus and receive, based on the received notification message, the data from the first server.

An information processing method according to another embodiment of the present technology includes establishing a connection with a first device via a network and receiving data addressed to a second device from the first device. In this method, notification request information for requesting to transmit a notification message for notifying presence of the data to the second device is transmitted to a server constantly connected to the second device. Then, a connection is established in response to a request from the second device that receives the notification message and the data is transmitted to the second device.

A program according to still another embodiment of the present technology causes an information processing apparatus to execute a reception step, a first transmission step, and a second transmission step. In the reception step, a connection with a first device is established via a network and data addressed to a second device is received from the first device. In the first transmission step, notification request information for requesting to transmit a notification message for notifying presence of the data to the second device is transmitted to a constantly connected server constantly connected to the second device. In the second transmission step, a connection with the second device is established in response to a request from the second device that receives the notification message and the data is transmitted to the second device.

### Effect of the Invention

As described above, according to the present technology, it is possible to reduce the system load on the cloud system and handle a huge number of devices by a single apparatus.

### BRIEF DESCRIPTION OF DRAWINGS

FIG. 1 A diagram showing a network configuration of a system in a first embodiment of the present technology.

FIG. 2 A block diagram showing a hardware configuration of a messaging server in the system.

FIG. 3 A block diagram showing a hardware configuration of a device in the system.

FIG. 4 A block diagram showing a software module configuration of each node in the system.

FIG. 5 A diagram showing an example of a notification means list of the messaging server.

FIG. 6 A diagram showing an example of a connection information list of the messaging server.

FIG. 7 A diagram schematically showing a flow of data transmission processing between devices if a notification means is a notification server.

FIG. 8 A diagram schematically showing a flow of data transmission processing between the devices if the notification means is a global IP.

FIG. 9 A diagram schematically showing a flow of data transmission processing between devices if the notification means is a UPnP IGD.

FIG. 10 A diagram schematically showing a flow of data transmission processing between devices if the notification means is a user setting.

FIG. 11 A flowchart showing a flow of operations of a message transmitter of a device that serves as a transmission source of the data.

FIG. 12 A flowchart showing a flow of operations of a notification means setting unit of a device that serves as a destination of the data.

FIG. 13 A flowchart showing a flow of operations of a notification server notification receiver of the device that serves as the destination of the data.

FIG. 14 A flowchart showing a flow of operations of a direct notification receiver of the device that serves as the destination of the data.

FIG. 15 A flowchart showing a flow of operations of a message receiver of the device that serves as the destination of the data.

FIG. 16 A flowchart showing a flow of operations of a connection processor of the notification server.

FIG. 17 A flowchart showing a flow of operations of a connection management unit of the notification server.

FIG. 18 A flowchart showing a flow of operations of a connection processor of the messaging server.

FIG. 19 A flowchart showing a flow of operations of a connection management unit of the messaging server.

FIG. 20 A flowchart showing a flow of operations of a message transmitter of the messaging server.

FIG. 21 A diagram showing a network configuration of a system in a second embodiment of the present technology.

FIG. 22 A diagram showing a software module configuration of each node in the system in the second embodiment of the present technology.

FIG. 23 A flowchart showing a flow of processing of determining a server corresponding to a device in the second embodiment of the present technology.

FIG. 24 A diagram showing an example of a messaging server assignment table created in the second embodiment of the present technology.

FIG. 25 A diagram showing an example of a notification server assignment table created in the second embodiment of the present technology.

FIG. 26 A diagram showing an example of a resolution table for determining a network address of a messaging server, which is created in the second embodiment of the present technology.

FIG. 27 A diagram showing an example of a resolution table for determining a network address of a notification server, which is created in the second embodiment of the present technology.

FIG. 28 A diagram schematically showing a flow of data transmission processing between devices in the second embodiment of the present technology.

FIG. 29 A flowchart showing a flow of operations of a connection processor of a messaging server in the second embodiment of the present technology.

FIG. 30 A flowchart showing a flow of operations of a connection management unit of the messaging server in the second embodiment of the present technology.

FIG. 31 A flowchart showing a flow of operations of a message transfer unit of the messaging server in the second embodiment of the present technology.

FIG. 32 A diagram showing a network configuration of a system in a third embodiment of the present technology.

FIG. 33 A flowchart showing a flow of operations of a connection management unit of a messaging server in the third embodiment of the present technology.

### MODE(S) FOR CARRYING OUT THE INVENTION

Hereinafter, embodiments according to the present technology will be described with reference to the drawings.

### First Embodiment

First, a first embodiment of the present technology will be described.

[Network Configuration of System]

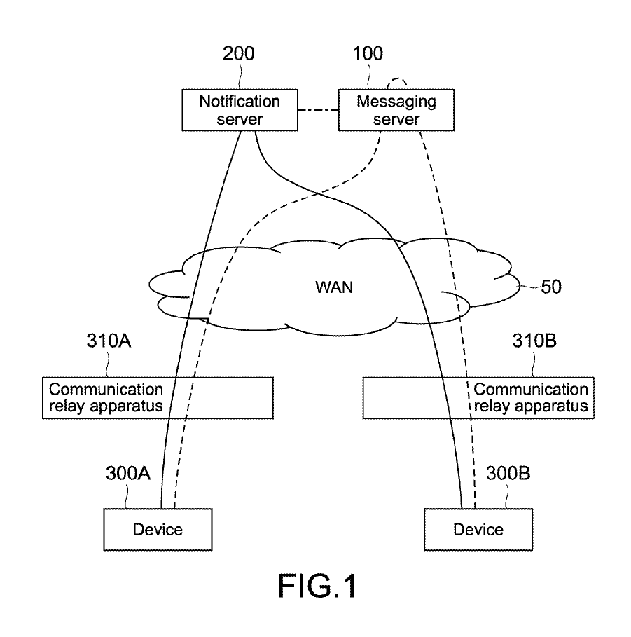

FIG. 1 is a diagram showing a network configuration of a system according to this embodiment.

As shown in the figure, this system includes a messaging server 100 and a notification server 200 in the cloud system and a plurality of devices 300 connectable to these servers via a wide area network (WAN).

In this embodiment, the one messaging server 100 and the one notification server 200 are provided in the cloud system.

The device 300 can be any information processing apparatus, for example, a smart phone, a cellular phone, a tablet personal computer (PC), a desk top PC, a laptop PC, a personal digital assistant (PDA), a portable AV player, an electronic book, a digital still camera, a cam coder, a television set, a personal video recorder (PVR), a game console, a car navigation system, or a digital photo frame. Although the figure shows only two devices 300A and 300B, the number of devices 300 may be three or more.

Each device 300 may communicate with the above-mentioned messaging server 100 and notification server 200 via a communication relay apparatus 310 and may directly communicate with these servers without the communication relay apparatus 310.

Each device 300 constantly connects to be communicable with the notification server 200, and establishes a connection with the messaging server 100 for communication in case of necessity. The messaging server 100 establishes connections with the notification server 200 and the devices 300 for communication in case of necessity.

The communication relay apparatus 310 means one that has a function of relaying communication between an internal network (device 300 side) and an external network (cloud system side) and prevents specifying and connecting to a particular internal device unless an external server uses a special means due to different addresses used in both the networks or a mechanism protecting security. A NAT router, a proxy server, and a fire wall are exemplified as such a communication relay apparatus 310.

As details will be described below, the messaging server 100 functions as a server that mediates communication between the devices 300 (e.g., transmission and reception of message). Further, the notification server 200 functions as one of notification means for transmitting a notification message indicating that data (message) transmitted from the device 300 is present to a device 300 that is a destination of the data. Other notification means will be described below.

In the following descriptions, the messaging server 100, the notification server 200, and the device 300 will be sometimes collectively referred to as “nodes.”

[Hardware Configuration of Messaging Server]

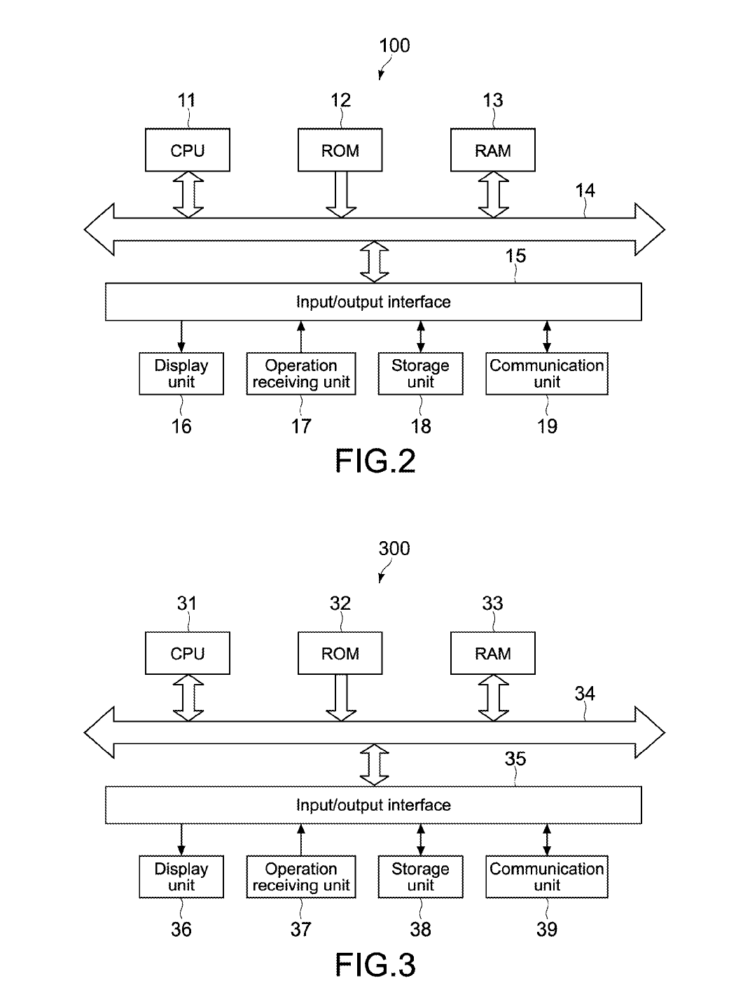

FIG. 2 is a diagram showing a hardware configuration of the messaging server 100. As shown in the figure, the messaging server 100 includes a central processing unit (CPU) 11, a read only memory (ROM) 12, a random access memory (RAM) 13, an input/output interface 15, and a bus 14 that connects them to one another.

The CPU 11 appropriately accesses the RAM 13 or the like in case of necessity and generally controls all the blocks of the messaging server 100 while performing various types of arithmetic processing. The ROM 12 is a non-volatile memory in which an OS and firmware such as programs and various parameters to be executed by the CPU 11 are fixedly stored. The RAM 13 is used as a working area or the like of the CPU 11 and temporarily stores the OS, the various applications being executed, various types of data being processed.

A display unit 16, an operation receiving unit 17, a storage unit 18, a communication unit 19, and the like are connected to the input/output interface 15.

The display unit 16 is, for example, a display device using a liquid crystal display (LCD), an organic electroluminescence display (OELD), a cathode ray tube (CRT), or the like.

The operation receiving unit 17 is, for example, a pointing device such as a mouse, a keyboard, a touch panel, or another input apparatus. If the operation receiving unit 17 is a touch panel, the touch panel may be integral with the display unit 16.

The storage unit 18 is, for example, a non-volatile memory including a hard disk drive (HDD), a flash memory (solid state drive; SSD), and another soli-state memory. The storage unit 18 stores the above-mentioned OS, various applications, various types of data. In particular, in this embodiment, the storage unit 18 stores a database of programs, notification means lists, connection information lists, and the like of a plurality of software modules to be described below.

The communication unit 19 is an NIC or the like for connecting to a WAN 50 and serves to communicate with the notification server 200 or the device 300.

[Hardware Configuration of Notification Server]

The notification server 200 has the same hardware configuration as that of the messaging server, and hence a description thereof will be omitted. In this embodiment, hardware modules of the notification server 200, which correspond to the CPU 11, the storage unit 18, and the communication unit 19 of the messaging server 100, will be referred to as a CPU 21, a storage unit 28, and a communication unit 29, respectively.

The storage unit 28 stores a database of programs, connection information lists, and the like of a plurality of software modules to be described below.

[Hardware Configuration of Device]

FIG. 3 is a diagram showing a hardware configuration of the device 300. As shown in the figure, the device 300 has basically the same hardware configuration as that of the messaging server 100. Specifically, the device 300 includes a CPU 31, a ROM 32, a RAM 33, an input/output interface 35, and a bus that connects them to one another. The device 300 further includes a display unit 36, an operation receiving unit 37, a storage unit 38, and a communication unit 39.

The display unit 36 may be built in the device 300 or may be externally connected to the device 300.

The storage unit 38 stores programs and various databases of a plurality of software modules to be described below and the like.

[Module Configurations of Each Device]

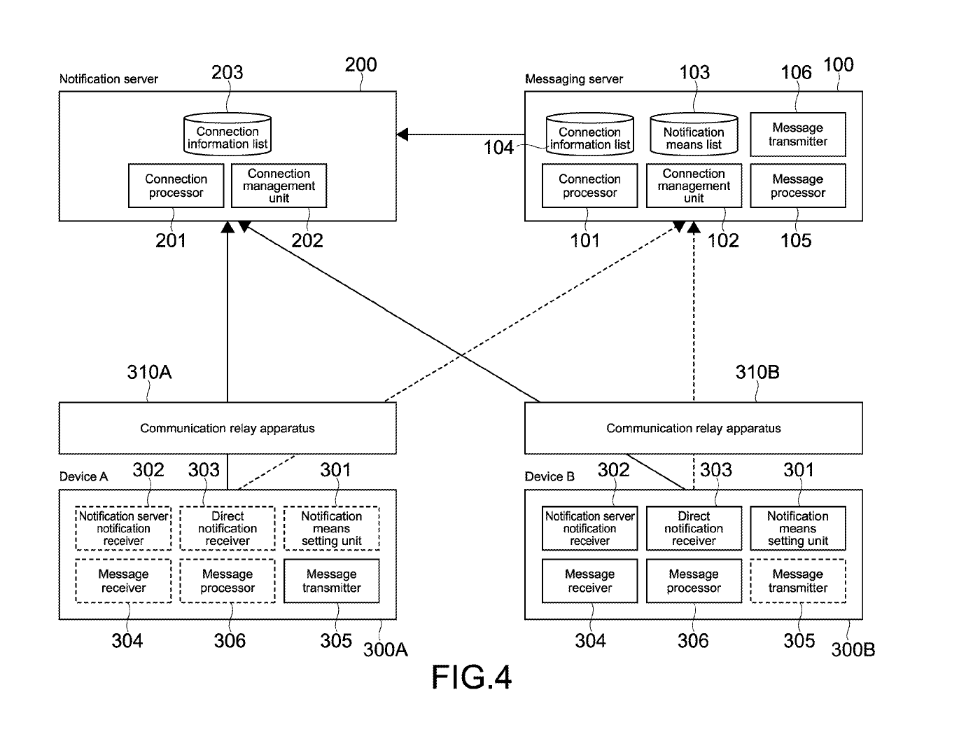

FIG. 4 is a diagram showing configurations of software modules of the messaging server 100, the notification server 200, and the device 300.

(Module Configurations of Messaging Server)

As shown in the figure, the messaging server 100 includes software modules of a connection processor 101, a connection management unit 102, a message processor 105, and a message transmitter 106, and databases of a notification means list 103 and a connection information list 104.

The connection processor 101 receives a connection request from the device 300 and establishes a connection with the device 300.

The connection management unit 102 manages all connections with the notification server 200 and the device 300 and processes, transmits, or transfers a received message.

The message processor 105 processes a received message addressed to the messaging server 100.

The message transmitter 106 transmits a message to the device 300 to be handled by the messaging server 100.

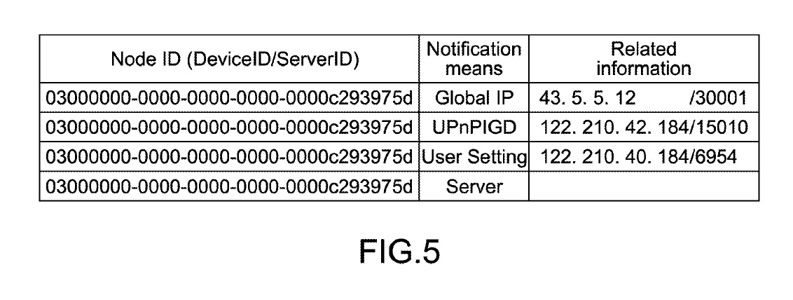

The notification means list 103 is a list of information on a notification means for notifying the device 300 of the presence of a message. FIG. 5 shows an example of the notification means list.

As will be described below, before actual communication, each device 300 communicates with the messaging server 100 and registers a notification means that the device 300 wishes the messaging server 100 to use when the messaging server 100 receives a message addressed to the device.

As shown in the figure, items of node IDs (device ID for device, server ID for server), notification means, and related information are described in the notification means list.

The node ID is an ID having, for example, 128 bits for uniquely identifying the messaging server 100, the notification server 200, and the devices 300.

The device ID is typically generated based on information embedded in advance in hardware of each device 300, such as a MAC address in WLAN/Ethernet (registered trademark) and an IMEI of a cellular phone, such that the device ID is a unique ID for each group of the devices 300. However, the device ID may be assigned in any form as long as its uniqueness can be ensured.

The server ID is an ID for uniquely identifying the messaging server 100 and the notification server 200 in the cloud system. Typically, an ID specified at the start of a server is used as the server ID for the purpose of replacing the server by another server if a failure occurs, for example. However, as in the device ID, the server ID may be set in any way.

The node ID indicates, for example, an ID type with upper bits and an ID specific to each node with lower bits. The ID type is, for example, “0300” in the case of the device ID, “0400” in the case of the server ID of the messaging server 100, or “0401” in the case of the server ID of the notification server 200.

Specifically, the device ID is, for example, “03000000-0000-0000-0000-0000c293975d” and the server ID is, for example, “04010000-0000-0000-0000-000000000123.” In the example of the figure, entries of a plurality of notification means associated with a single device ID are shown. Actually, the entry of the notification means is described for each of nodes having different IDs (messaging server 100, notification server 200, and plurality of devices 300).

In this embodiment, as the notification means, there are four of “global IP,” “UPnP IGD,” “user setting,” and “server.” The notification server 200 is provided for the case where direct communication from an external device (messaging server 100) cannot be performed due to the communication relay apparatus 310. Therefore, in the case where the communication relay apparatus 310 is not present or in the case where a special setting can be made in the communication relay apparatus 310, the messaging server 100 is capable of performing notification without the notification server 200.

“Global IP” shows that the global IP address is assigned to the device 300 (e.g., mobile device) and a direct connection from the messaging server 100 to the device 300 can be performed without the communication relay apparatus 310. In this entry, as the related information, the global IP address and the port number of the node corresponding to the node ID are described.

“UPnP IGD” shows that a setting in which the communication relay apparatus 310 transfers communication from an external device to a particular internal node according to an instruction from a local node connected thereto can be made and a connection from the messaging server 100 to the device 300 via the communication relay apparatus 310 can be performed. Specifically, this is applied to the case where the NAT router serving as the communication relay apparatus 310 supports a NAT traversal mechanism using a UPnP IGD protocol. In this case, the NAT router is set such that the internal device 300 determines a port number on a WAN 50 side and a port number on a LAN side in cooperation with the messaging server 100 and transfers communication with respect to the port number on the WAN 50 side to the IP address/port number on the LAN side. The messaging server 100 stores the IP address and the port number on the WAN side in the notification means list as the related information, and uses the stored IP address and port number for communicating with the device 300.

“User setting” shows that the transfer setting as in the “UPnP IGD” can be performed not according to the instruction from the device 300 but by the user using a port forwarding mechanism to manually change such a setting. Also in this case, the set IP address and port number are stored as the related information.

“Server” shows that the messaging server 100 can be connected to each device 300 via the notification server 200. In the case where each device 300 is connected to the cloud system via the normal communication relay apparatus 310 that does not support the NAT traversal mechanism and the like, the notification means is used.

In this notification means list, information on the same device may also be present as a plurality of entries. For example, it is applied to the case where the device 300 is a portable terminal such as a smart phone and is connected to both a network for a cellular phone and a wireless LAN. Further, in actual operation, entries of the list may be provided with expiration dates.

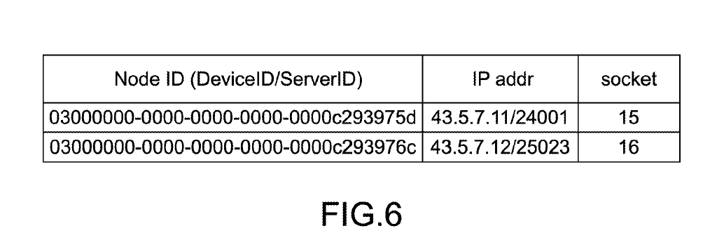

The connection information list 104 is a list in which information on a connection maintained by the messaging server 100 at a certain point of time is described. FIG. 6 shows an example thereof. As shown in the figure, items of the node ID, the IP address, and the socket number of the notification server 200 or the device 300 to which the messaging server 100 is being connected are described in the connection information list 104. Every time a connection with the notification server 200 or the device 300 is established, the corresponding entry is added to the connection information list 104. When the connection is released, the corresponding entry is removed from the connection information list 104.

(Module Configurations of Notification Server)

As shown in FIG. 4, the notification server 200 includes software modules of a connection processor 201 and a connection management unit 202 and a connection information list 203 serving as a database.

The connection processor 201 receives a connection request from the device 300 and establishes a connection.

The connection management unit 202 manages all connections between the messaging server 100 and the devices 300. When receiving a notification request from the messaging server 100, the connection management unit 202 transmits a notification message to the corresponding device 300.

The connection information list 203 is a list in which information on a connection maintained by the notification server 200 at a certain point of time is described. A configuration thereof is the same as that of the connection information list 104 of the messaging server 100.

(Module Configurations of Device)

As shown in FIG. 4, each device 300 includes software modules of a notification means setting unit 301, a notification server notification receiver 302, a direct notification receiver 303, a message receiver 304, a message transmitter 305, and a message processor 306.

The notification means setting unit 301 sets, in the messaging server 100, a notification means that can be used by the device 300.

The notification server notification receiver 302 is connected to the notification server 200 and receives a notification message.

The direct notification receiver 303 directly receives a notification message from the messaging server 100 without the notification server 200.

The message receiver 304 connects to the messaging server 100 and receives data (message) transmitted from the other device 300.

The message transmitter 305 connects to the messaging server 100 and transmits data (message) addressed to the other device.

The message processor 306 processes data (message) received from the messaging server 100.

The device 300A serving to transmit a message only needs to at least include the message transmitter 305, and hence, in the figure, the other module blocks are shown by dashed lines. Of course, the device 300A serving as a transmitter may include the same modules as those of the device 300B serving as a receiver. Similarly, although the message transmitter 305 in the device 300B serving to receive a message is shown by dashed lines in the figure, the device 300B may also include the message transmitter 305.

[Operations of System]

Next, operations of the messaging server 100, the notification server 200, and the devices 300 in the thus configured system will be described focusing on data (message) transmission processing between the devices 300. In this embodiment and other embodiments, the operations in the nodes constituting the system are cooperatively performed by the CPU and the software modules executed under control thereof.

Before data (message) transmission processing, the messaging server 100 and the notification server 200 notify each device 300 of a notification server ID, a messaging server ID, network addresses (host name or IP address/port number) corresponding thereto, and the like as initial setting information in advance.

(Data Transmission Processing Example: Case where Notification Means is Notification Server)

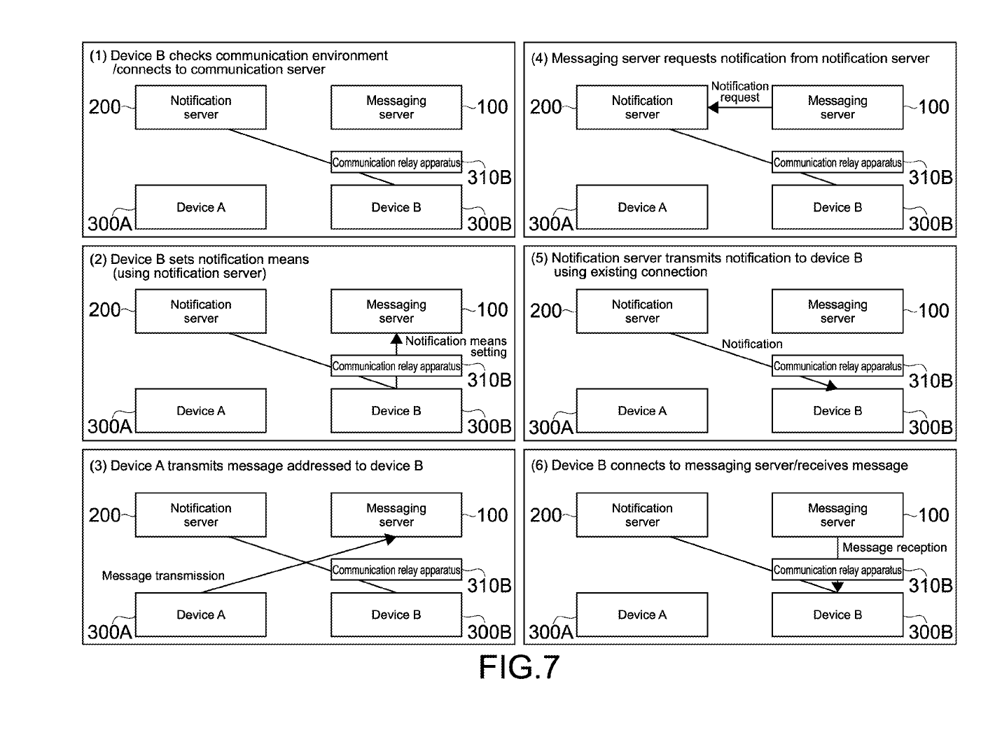

First, a flow of data (message) transmission processing between the devices 300 in the case where the notification means is the notification server 200 will be described. FIG. 7 is a diagram schematically showing an outline of the flow of data transmission processing from the device 300A to the device 300B in this case.

As shown in the figure, after checking an environment of communication with the cloud system, the device 300B (destination) serving to receive a message first connects to the notification server 200 via a communication relay apparatus 310B ((1) in figure). The connection is constantly maintained.

Subsequently, the device 300B connects to the messaging server 100 via the communication relay apparatus 310B and sets the notification server 200 as the notification means (transmits notification means setting information) ((2) in figure).

Subsequently, the device 300A serving as a message transmission source transmits a message addressed to the device 300B to the messaging server 100 ((3) in figure).

Subsequently, the messaging server 100 that has received the message transmits, to the notification server 200, a notification message transmission request (notification request) for notifying the presence of the message to the device 300B from the device 300A ((4)).

Subsequently, the notification server 200 that has received the notification request uses the already established connection with the device 300B to transmit the notification message to the device 300B ((5) in figure).

Then, the device 300B that has received the notification message establishes a connection with the messaging server 100 via the communication relay apparatus 310B and receives the message from the device 300A ((6) in figure).

(Data Transmission Processing Example: Case where Notification Means is Global IP)

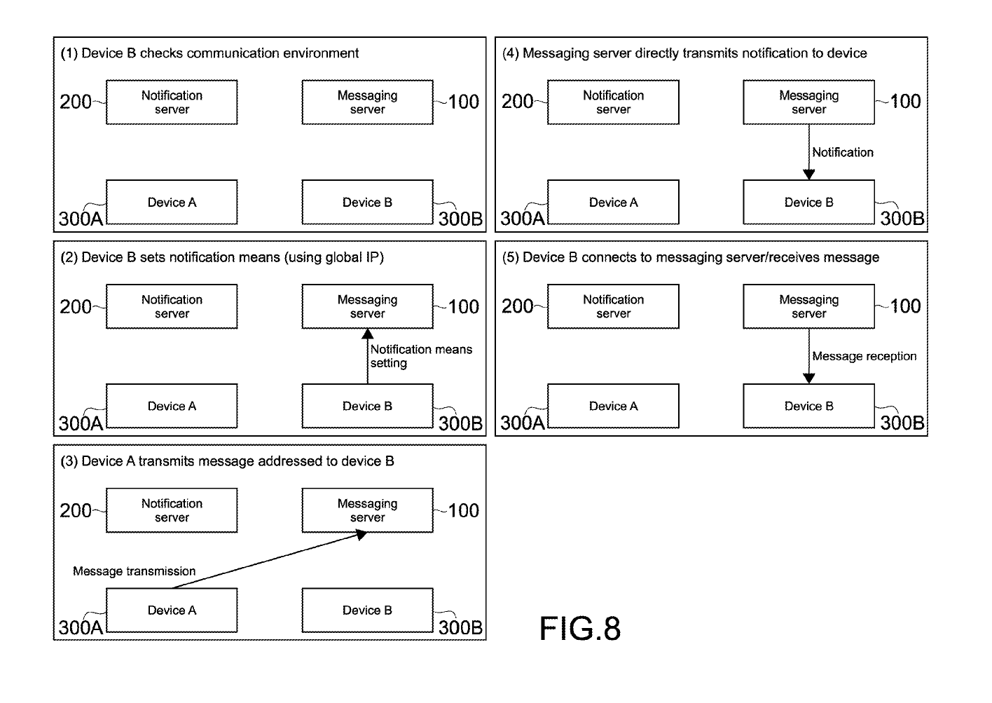

Next, a flow of data (message) transmission processing between the devices 300 in the case where the notification means is the global IP will be described. FIG. 8 is a diagram schematically showing an outline of the flow of data transmission processing from the device 300A to the device 300B in this case.

As shown in the figure, the device 300B (destination) serving to receive a message first checks an environment of communication with the cloud system ((1) in figure).

Subsequently, after checking a capability of directly communicating with the cloud system, the device 300B connects to the messaging server 100 and sets a global IP as the notification means ((2) in figure).

Subsequently, the device 300A serving as the message transmission source transmits the message addressed to the device 300B to the messaging server 100 ((3) in figure).

Subsequently, the messaging server 100 that has received the message establishes a connection with the device 300B and directly transmits the notification message to the device 300B ((4) in figure).

Then, the device 300B that has received the notification message establishes a connection with the messaging server 100 and receives the message from the device 300A ((5) in figure).

(Data Transmission Processing Example: Case where Notification Means is UPnP IGD)

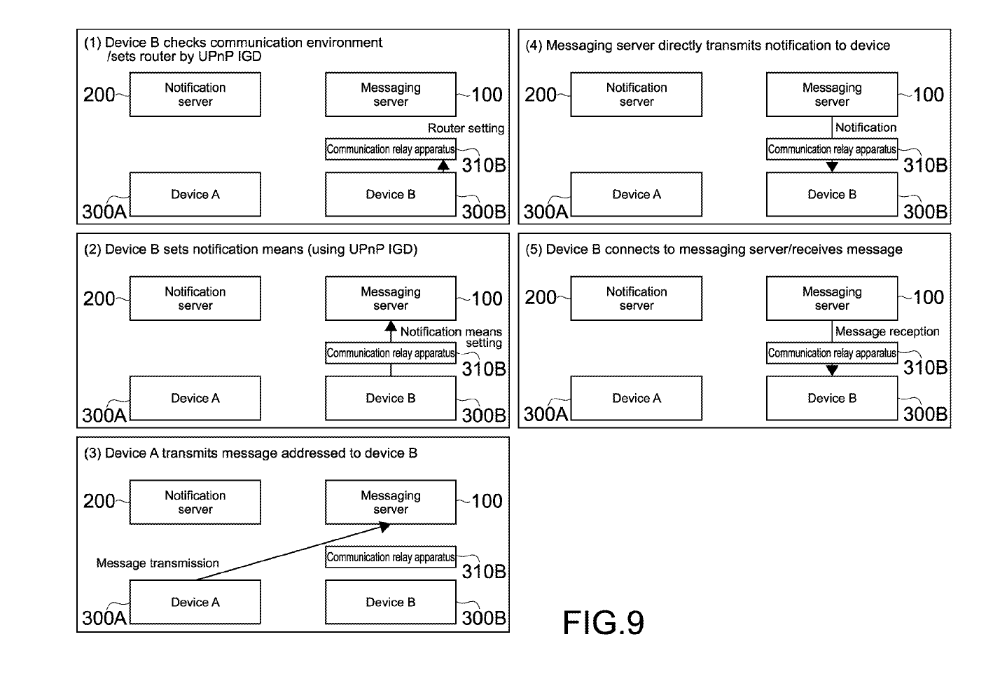

Next, a flow of data (message) transmission processing between the devices 300 in the case where the notification means is the UPnP IGD will be described. FIG. 9 is a diagram schematically showing an outline of the flow of data transmission processing from the device 300A to the device 300B in this case.

As shown in the figure, after checking an environment of communication with the cloud system, the device 300B (destination) serving to receive a message first uses the NAT traversal mechanism using the UPnP IGD to set the communication relay apparatus 310B (router) to transfer communication from the cloud system to the device 300B ((1) in figure).

Subsequently, the device 300B connects to the messaging server 100 via the communication relay apparatus 310B and sets an UPnP IGD as the notification means ((2) in figure).

Subsequently, the device 300A serving as the message transmission source transmits the message addressed to the device 300B to the messaging server 100 ((3) in figure).

Subsequently, the messaging server 100 that has received the message establishes a connection with the device 300B based on the setting of the UPn PIGD and transmits the notification message to the device 300B via the communication relay apparatus 310B ((4) in figure).

Then, the device 300B that has received the notification message establishes a connection with the messaging server 100 based on the setting of the UPn PIGD receives the message from the device 300A via the communication relay apparatus 310B ((5) in figure).

(Data Transmission Processing Example: Case where Notification Means is User Setting)

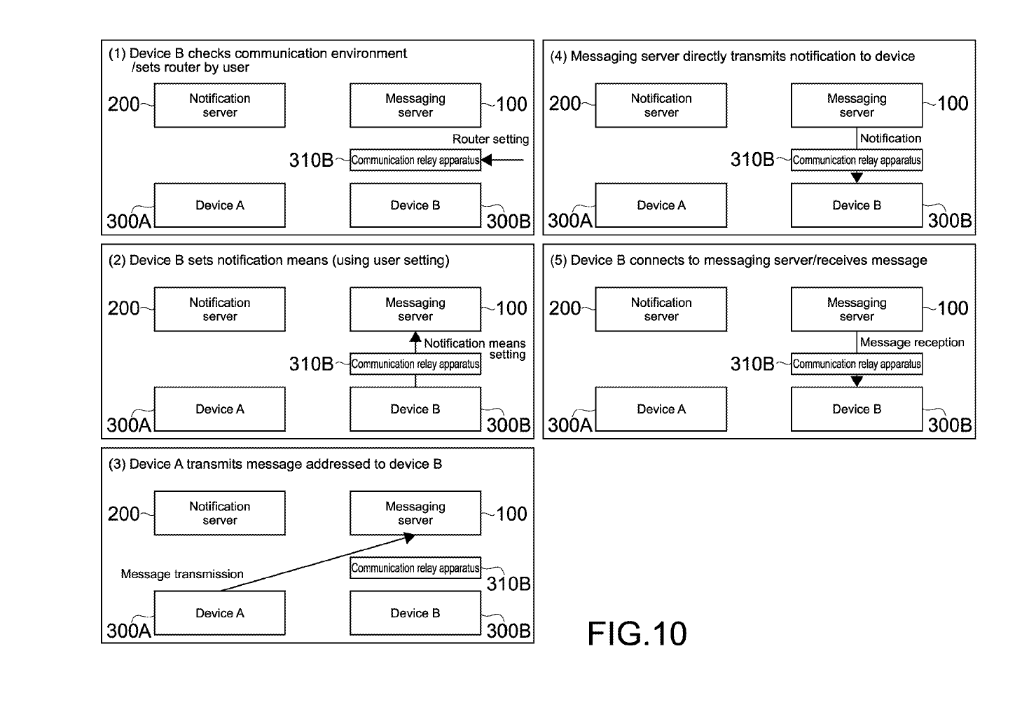

Next, a flow of data (message) transmission processing between the devices 300 in the case where the notification means is the user setting will be described. FIG. 10 is a diagram schematically showing an outline of the flow of data transmission processing from the device 300A to the device 300B in this case.

As shown in the figure, after checking an environment of communication with the cloud system, the user of the device 300B (destination) serving to receive a message first uses the port forwarding mechanism to manually set the communication relay apparatus 310B (router) to transfer the communication from the cloud system to the device 300B ((1) in figure).

Subsequently, the device 300B connects to the messaging server 100 via the communication relay apparatus 310B and sets a user setting as the notification means ((2) in figure).

Subsequently, the device 300A serving as the message transmission source transmits the message addressed to the device 300B to the messaging server 100 ((3) in figure).

Subsequently, the messaging server 100 that has received the message establishes a connection with the device 300B based on the setting by the port forwarding mechanism and transmits the notification message to the device 300B via the communication relay apparatus 310B ((4) in figure).

Then, the device 300B that has received the notification message establishes a connection with the messaging server 100 based on the setting by the port forwarding mechanism and receives the message from the device 300A via the communication relay apparatus 310B ((5) in figure).

(Operations of Device)

Next, operations of the device 300 in the above-mentioned transmission processing will be described.

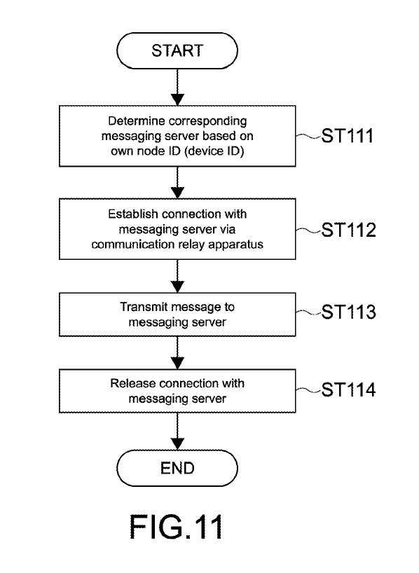

FIG. 11 is a flowchart showing a flow of operations of the message transmitter 305 of the device 300A serving as the message transmission source.

As shown in the figure, the message transmitter 305 first determines, based on the node ID (device ID) of the device 300A, the corresponding messaging server 100 (Step 111). As described above, in this embodiment, only one messaging server 100 is provided and each device 300 is informed of the server ID and the network address thereof in advance, and hence the message transmitter 305 identifies the messaging server 100 based on this information.

Subsequently, the message transmitter 305 establishes a connection with the messaging server 100 via a communication relay apparatus 310A (Step 112).

Subsequently, the message transmitter 305 transmits the message addressed to the device 300B to the messaging server 100 (Step 113).

After completing the transmission of the message, the message transmitter 305 releases a connection with the messaging server 100 (Step 114).

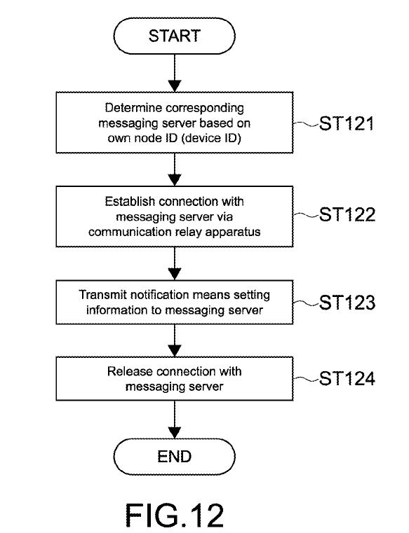

FIG. 12 is a flowchart showing a flow of operations of the notification means setting unit 301 of the device 300B serving as a destination of the data (message).

As shown in the figure, the notification means setting unit 301 first determines, based on the node ID (device ID) of the device 300B, the corresponding messaging server 100 (Step 121). As described above, in this embodiment, the device 300B is also notified of the server ID and the network address of the messaging server 100 in advance, and hence the notification means setting unit 301 identifies the messaging server 100 based on this information.

Subsequently, the notification means setting unit 301 establishes a connection with the messaging server 100 via the communication relay apparatus 310B (Step 122).

Subsequently, the notification means setting unit 301 transmits, to the messaging server 100, the notification means setting information in which at least one of the above-mentioned four notification means is identified (Step 123).

After completing the transmission of the notification means setting information, the notification means setting unit 301 releases the connection with the messaging server 100 (Step 124).

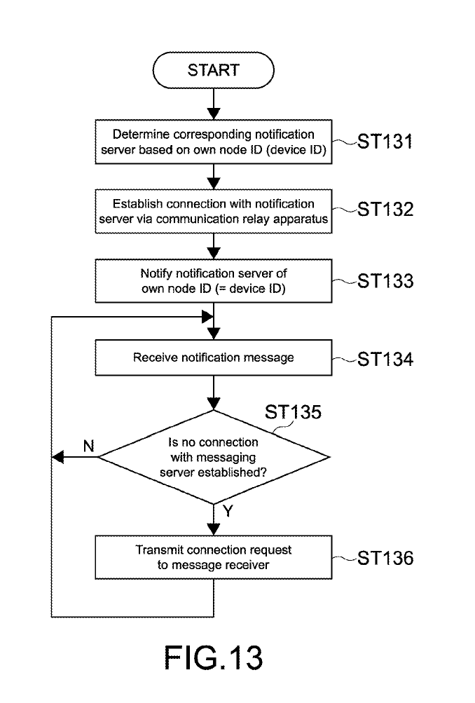

FIG. 13 is a flowchart showing a flow of operations of the notification server notification receiver 302 of the device 300B. As described above, the operations are performed when the notification means is set to the notification server 200.

As shown in the figure, the notification server notification receiver 302 first determines, based on the node ID (device ID) of the device 300B, the corresponding notification server 200 (Step 131). As described above, in this embodiment, only one notification server 200 is provided and each device 300 is informed of the server ID and the network address thereof in advance, and hence the notification server notification receiver 302 identifies the notification server 200 based on this information.

Subsequently, the notification server notification receiver 302 establishes a connection with the notification server 200 via the communication relay apparatus 310B (Step 132).

Subsequently, the notification server notification receiver 302 notifies the notification server 200 of the node ID (device ID) of the device 300B (Step 133).

Subsequently, the notification server notification receiver 302 receives, from the notification server 200 that has received a notification request from the messaging server 100, a notification message (Step 134).

Subsequently, the notification server notification receiver 302 that has received the notification message determines whether or not no connection with the messaging server 100 is established at that point of time (Step 135).

If it is determined that no connection with the messaging server 100 is established (Yes), the notification server notification receiver 302 transmits, to the message receiver 304, a request to establish the connection with the messaging server 100 (Step 136).

The notification server notification receiver 302 repeats processing of from Steps 134 to 136 described above every time the notification message is received.

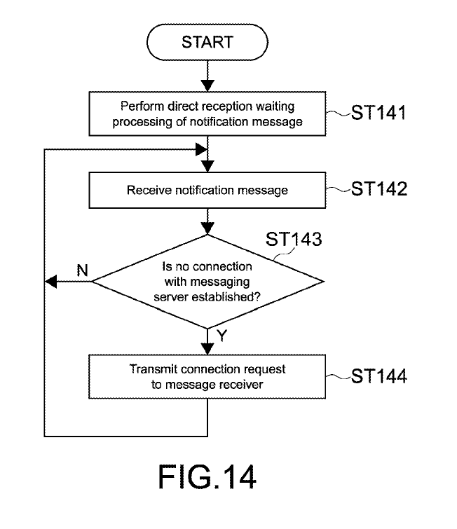

FIG. 14 is a flowchart showing a flow of operations of the direct notification receiver 303 of the device 300B. As described above, the operations are performed when the notification means is set to one other than the notification server 200.

As shown in the figure, the direct notification receiver 303 first waits for reception of the notification message transmitted from the messaging server 100 (Step 141).

Subsequently, the direct notification receiver 303 receives the notification message from the messaging server 100 (Step 142).

Subsequently, after receiving the notification message, the direct notification receiver 303 determines whether or not no connection with the messaging server 100 is established at that point of time (Step 143).

If it is determined that no connection with the messaging server 100 is established (Yes), the direct notification receiver 303 requests the message receiver 304 to establish the connection with the messaging server 100 (Step 144).

The direct notification receiver 303 repeats processing of from Steps 142 to 144 described above every time the notification message is received.

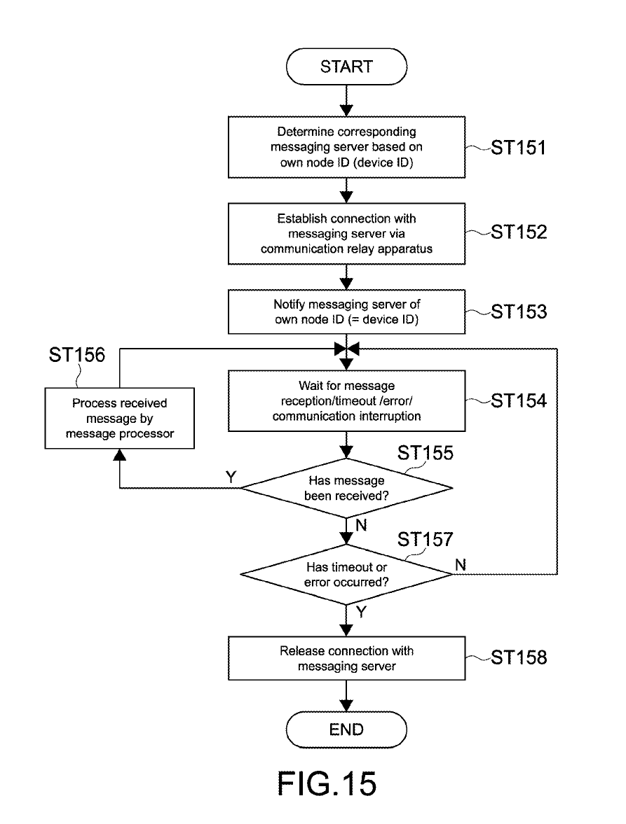

FIG. 15 is a flowchart showing a flow of operations of the message receiver 304 and the message processor 306 of the device 300B.

As shown in the figure, the message receiver 304 first determines the corresponding messaging server 100 based on the node ID (device ID) of the device 300B in the same manner described above (Step 151).

Subsequently, the message receiver 304 establishes a connection with the messaging server 100 via the communication relay apparatus 310B (directly without communication relay apparatus 310B if notification means is global IP) (Step 152).

Subsequently, the message receiver 304 notifies the messaging server 100 of the node ID (device ID) of the device 300B (Step 153).

Subsequently, the message receiver 304 waits for any of message reception from the messaging server 100, a time-out, an error, and a communication interruption (Step 154).

If the message is received (Yes in Step 155), the message processor 306 processes the received message (Step 156).

If the message is not received and a time-out or an error occurs (Yes in Step 157), the message receiver 304 releases the connection with the messaging server 100 (Step 158).

The message receiver 304 and the message processor 306 repeat processing of from Steps 154 to 158 described above every time the connection with the messaging server 100 is established.

(Operations of Notification Server)

Next, operations of the notification server 200 in the above-mentioned transmission processing will be described.

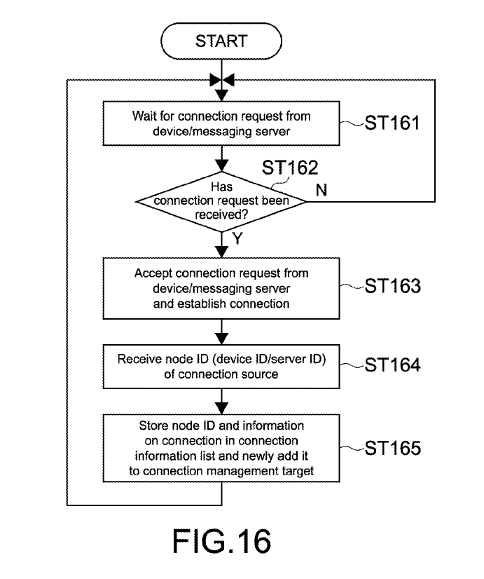

FIG. 16 is a flowchart showing a flow of operations of the connection processor 201 of the notification server 200.

As shown in the figure, the connection processor 201 first waits for a connection request from the device 300 or the messaging server 100 (Step 161).

If a connection request from the device 300 or the messaging server 100 is received (Yes in Step 162), the connection processor 201 accepts the connection request and establishes a connection (Step 163).

Subsequently, the connection processor 201 receives, from the device 300 or the messaging server 100 serving as a connection source, a node ID thereof (device ID of device 300 or server ID of messaging server 100) (Step 164).

Then, the connection processor 201 records, in the connection information list 203, the node ID and information on the connection (IP address and socket number) and newly adds them to a connection management target (Step 165).

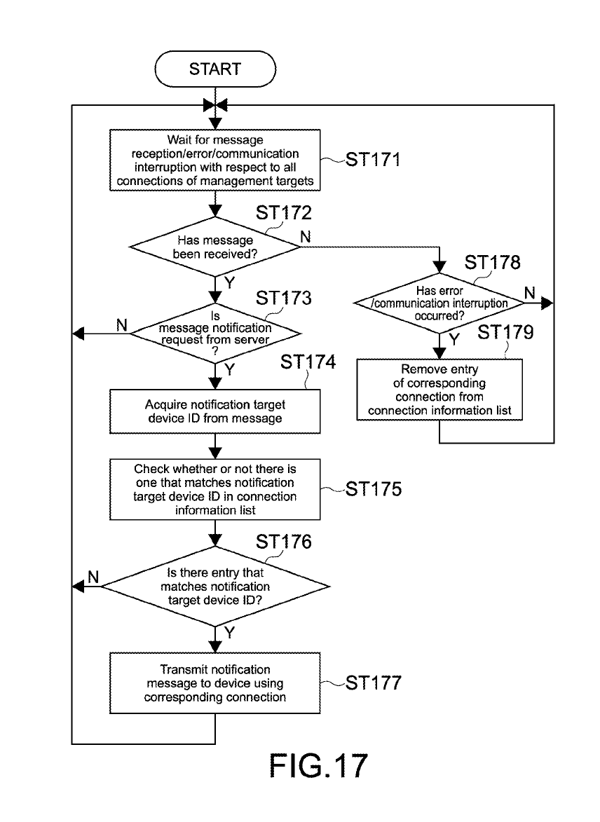

FIG. 17 is a flowchart showing a flow of operations of the connection management unit 202 of the notification server 200.

As shown in the figure, the connection management unit 202 first waits for any of message reception, an error, and a communication interruption with respect to all connections managed by the use of the connection information list 203 (Step 171).

Subsequently, the connection management unit 202 determines whether or not the message has been received (Step 172).

If it is determined that the message has been received (Yes), the connection management unit 202 determines whether or not the message is a notification request from the messaging server 100 (Step 173).

If it is determined that the message is the notification request from the messaging server 100 (Yes), the connection management unit 202 acquires, from the received message, the device ID of the device 300 serving as a notification target (transmission target of notification message) (Step 174).

Subsequently, the connection management unit 202 determines whether or not an entry that matches the acquired device ID is present in the connection information list 203 (Step 175).

If it is determined that the entry that matches the acquired device ID is present (Yes in Step 176), the connection management unit 202 uses the connection (IP address and socket number) corresponding to the entry to transmit the notification message to the device 300 serving as the target (Step 177).

In Step 172 described above, if it is determined that the message is not received (No), the connection management unit 202 determines whether or not an error or a communication interruption has occurred with respect to any of connections of the management targets (Step 178).

If the error or the communication interruption has occurred (Yes), the connection management unit 202 excludes, from the connection information list 203, an entry associated with the connection in which the error or the communication has occurred (Step 179).

(Operations of Messaging Server)

Next, operations of the messaging server 100 in the above-mentioned transmission processing will be described.

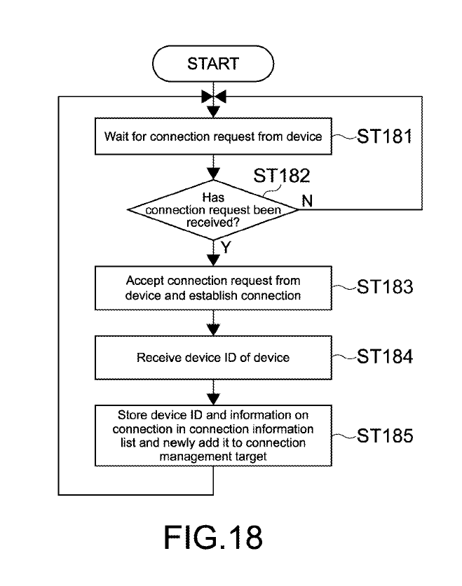

FIG. 18 is a flowchart showing a flow of operations of the connection processor 101 of the messaging server 100.

As shown in the figure, the connection processor 101 first waits for a connection request from the device 300 (Step 181).

If the connection request is received from the device 300 (Yes in Step 182), the connection processor 101 accepts a connection request from the device 300 and establishes a connection (Step 183).

Subsequently, the connection processor 101 receives, from the device 300 serving as the connection source, its device ID (Step 184).

Then, the connection processor 101 records, in the connection information list 104, the device ID and information on the connection (IP address and socket number) and newly adds the device 300 to the connection management target (Step 185).

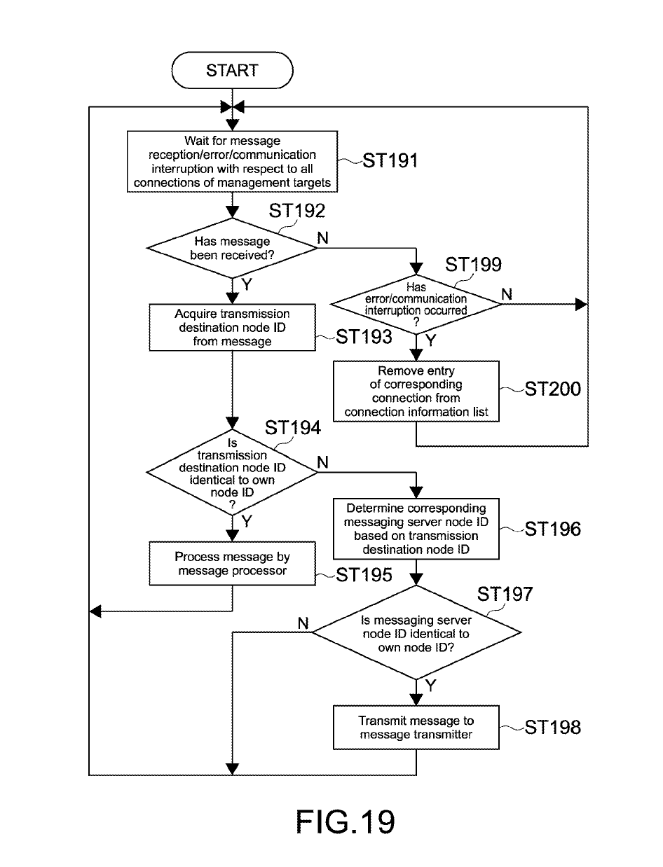

FIG. 19 is a flowchart showing a flow of operations of the connection management unit 102 and the message processor 105 of the messaging server 100.

As shown in the figure, the connection management unit 102 first waits for any of message reception, an error, and a communication interruption with respect to all connections managed by the use of the connection information list 104 (Step 191).

Subsequently, the connection management unit 102 determines whether or not the message has been received (Step 192).

If it is determined that the message has been received (Yes), the connection management unit 102 acquires, from the message, the node ID set as a transmission destination thereof (Step 193).

Subsequently, the connection management unit 102 determines whether or not the acquired node ID is the node ID (server ID) of the messaging server 100 (Step 194).

If it is determined that the node ID is the node ID of the messaging server 100 (Yes), the message processor 105 processes the message (Step 195).

If it is determined that the node ID of the transmission destination is not the node ID of the messaging server 100 (No), the connection management unit 102 determines, based on the node ID set as the transmission destination, the node ID of the messaging server corresponding thereto (Step 196).

As described above, in this embodiment, only one messaging server 100 is provided, and hence the connection management unit 102 determines that the node ID of the server corresponding to the transmission destination is its own node ID (messaging server 100) (Yes in Step 197).

Then, the connection management unit 102 passes the message to the message transmitter 106 (Step 198).

In Step 192 described above, it is determined that the message is not received (No), the connection management unit 102 determines whether or not an error or a communication interruption has occurred with respect to any of connections of the management targets (Step 199).

If the error or the communication interruption has occurred (Yes), the connection management unit 102 excludes, from the connection information list 104, an entry associated with the connection in which the error or the communication interruption has occurred (Step 200).

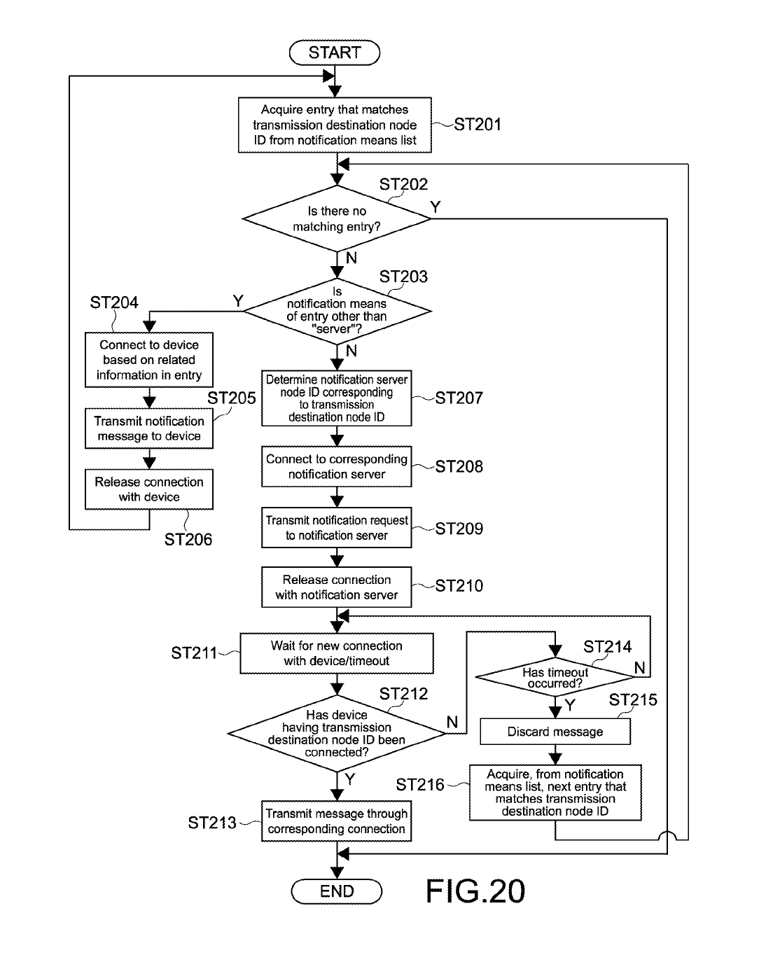

FIG. 20 is a flowchart showing a flow of operations of the message transmitter 106 of the messaging server 100.

As shown in the figure, the message transmitter 106 first acquires, from the notification means list 103, the entry that matches the node ID set as the transmission destination (Step 201).

It is determined that the entry that matches the node ID is not present in the notification means list 103 (Yes in Step 202), the message transmitter 106 terminates processing.

It is determined that the entry that matches the node ID is present (No in Step 202), the message transmitter 106 determines whether or not the notification means of the entry is set to one other than the notification server 200 (Step 203).

It is determined that the notification means is set to one other than the notification server 200 (Yes), the message transmitter 106 establishes, based on the related information on the entry, a connection with the device 300 (300B) serving as the message transmission destination (Step 204).

Subsequently, the message transmitter 106 uses this connection to transmit the notification message to the device 300 (Step 205).

When the transmission of the notification message is completed, the message transmitter 106 releases the connection with the device 300 (Step 206).

If it is determined in Step 203 described above that the notification means is set to the notification server 200 (No), the message transmitter 106 determines, based on the node ID set as the transmission destination, the node ID (server ID) of the notification server 200 corresponding thereto (Step 207).

Subsequently, the message transmitter 106 transmits, to the notification server 200 having the node ID, a notification request to the device 300, which is set as the transmission destination of the message, together with its node ID (device ID) (Step 209). When the transmission is completed, the message transmitter 106 releases the connection with the notification server 200 (Step 210).

Subsequently, the message transmitter 106 waits for a new connection from the device 300 serving as the message transmission destination or a time-out (Step 211).

It is determined that the device 300 having the node ID of the transmission destination has been connected to the messaging server 100 (Yes in Step 212), the message transmitter 106 uses a connection corresponding to the node ID to transmit the message to the device 300 (Step 213).

If there is no connection from the device 300 having the node ID of the transmission destination (time-out has occurred) in a predetermined period of time after a notification request to the notification server 200 is transmitted (Yes in Step 214), the message transmitter 106 discards the message (Step 215).

Then, the message transmitter 106 acquires, from the notification means list 103, a next entry that matches the node ID of the transmission destination (Step 216) and repeats processing after Step 202 described above.

[Conclusion]

As discussed above, in this embodiment, the cloud system is provided with, in addition to the messaging server 100, the notification server 200 serving as the notification means for the device 300, and hence each device 300 can be constantly connected to the cloud system even if the communication relay apparatus 310 is present. Further, the load on the messaging server 100 is accordingly reduced.

In comparison with the case where all the devices 300 are constantly connected to the messaging server 100, an advantage in the case where all the devices 300 are constantly connected to the notification server 200 and then connected to the messaging server 100 only in case of necessity is that the later can significantly increase the number of devices 300 that can be connected to a single server. For example, provided that the number of devices that can be supported by the single messaging server 100 is 50,000, the number of devices that can be supported by the notification server 200 is 1,000,000.

In the messaging server 100, processing to be performed is complicated and it is necessary to prepare a sufficient communication buffer size per one connection in view of the communication efficiency. However, in the notification server 200, the notification server 200 only needs to have a function of transmitting a very small message (notification message) to the device 300, processing is very simple, and only a minimum communication buffer is necessary. Therefore, a resource necessary for the single notification server 200 can be minimized as possible.

In addition, in this embodiment, if, as another notification means, the communication relay apparatus 310 can be set to transfer external communication to a particular internal device 300, the load on the cloud system is further reduced by the mechanism. In some case, means other than the notification server such as an UPnP IGD cannot be, by itself, applied to communication between all the devices 300. However, in a system assuming the notification server 200, it effectively functions as means for reducing the load on the entire system.

### Second Embodiment

Next, a second embodiment of the present technology will be described. In this embodiment, portions having the same configurations and functions as those of the first embodiment will be denoted by the same reference symbols and descriptions thereof will be omitted.

[Network Configuration of System]

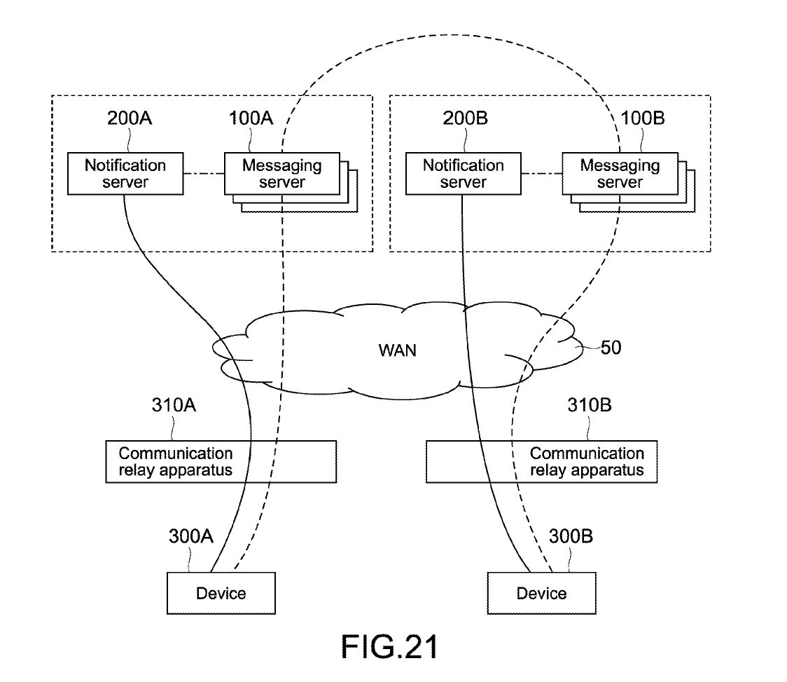

FIG. 21 is a diagram showing a network configuration of a system according to this embodiment.

In the first embodiment, only one messaging server 100 and one notification server 200 are provided in the cloud system (WAN 50). However, as shown in the figure, in this embodiment, a plurality of messaging servers 100 and a plurality of notification servers 200 are provided. As will be described below, with such a configuration, a message from the device 300 is relayed among the plurality of messaging servers 100.

Although six messaging servers 100 and two notification servers 200 are shown in the figure, the number of messaging servers 100 and notification servers 200 is not limited thereto.

[Module Configurations of Each Device]

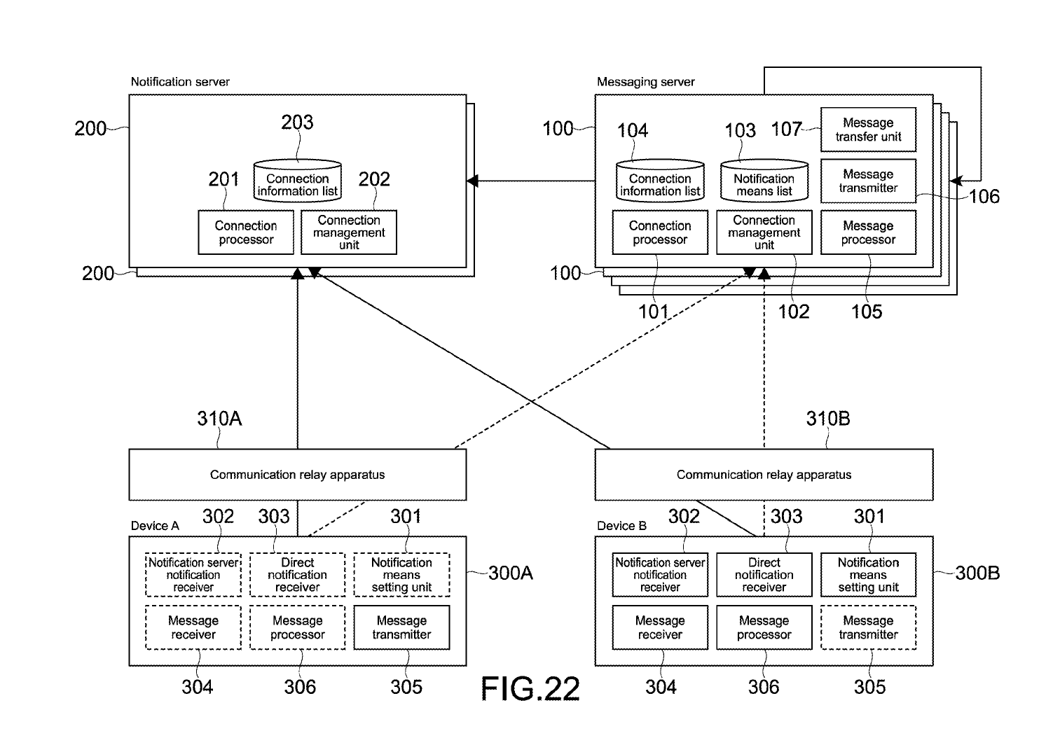

FIG. 22 is a view showing a configuration of software modules included in each of the messaging servers 100, the notification servers 200, and the devices 300.

(Module Configurations of Messaging Server)

As shown in the figure, the messaging server 100 includes a message transfer unit 107 in addition to the same modules as those of the first embodiment (see FIG. 4).

In order to transmit a message to the device 300 not handled by the messaging server 100 (100A), the message transfer unit 107 transfers the message to the other messaging server 100 (100B).

In this embodiment, the configuration of the modules of the notification servers 200 and the devices 300 are the same as those described in the first embodiment.

[Operations of System]

Next, operations of the messaging server 100, the notification server 200, and the devices 300 in the thus configured system will be described focusing on data (message) transmission processing between the devices 300.

(Processing of Determining Server to be Used by Device)

In this embodiment, the plurality of messaging servers 100 and the plurality of notification servers 200 are provided, and hence, after message transmission processing, which of the messaging servers 100 and which of the notification servers 200 each device 300 uses is determined in advance. A corresponding relationship between this device 300 and each server used by it is determined by a predetermined calculation based on the device ID. Determination processing will be first described.

Determination processing described hereinafter is an example and can be performed by both of the messaging server 100 and the device 300 and the corresponding relationship may be determined by any way as long as it can be ensured that the both can obtain the same result.

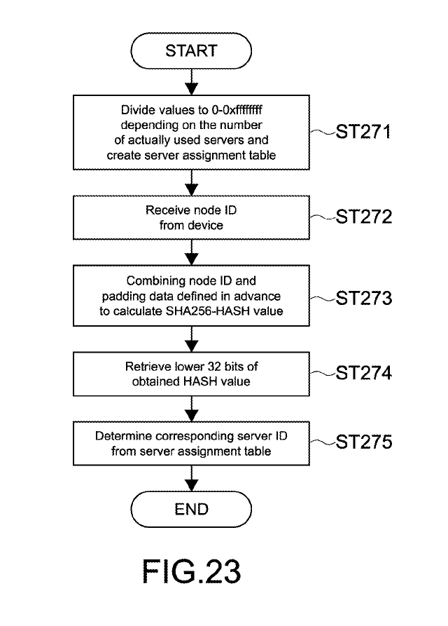

FIG. 23 is a flowchart showing a flow of processing of determining the server corresponding to the device 300. Although processing to be described in the following will be described as one to be performed by the message transfer unit 107 of the messaging server 100, it may be performed by another module.

As shown in the figure, with respect to each of the messaging server 100 and the notification server 200, the message transfer unit 107 first divides values of from 0 to 0xffffffff depending on the number of servers to be actually used and a server assignment table is created (Step 271). The table is stored in the storage unit 18, for example.

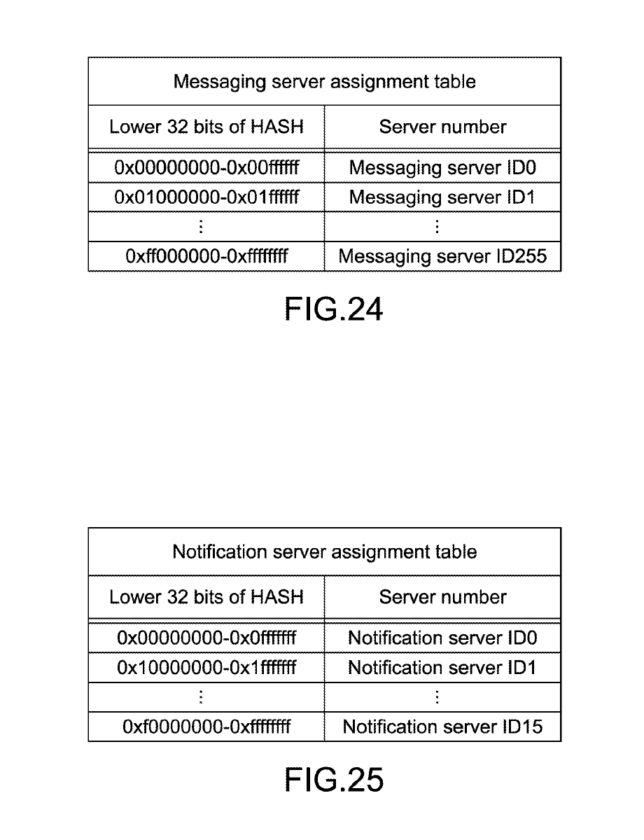

FIG. 24 is a view showing an example of a server assignment table with respect to the messaging server 100. FIG. 25 is a view showing an example of a server assignment table with respect to the notification server 200. As shown in both of the figures, the values of from 0 to 0xffffffff are divided for each of predetermined ranges. The value range is assigned with each of the servers ID of the messaging servers 100 and the notification servers 200.

Subsequently, the message transfer unit 107 receives the node ID from the device 300 serving as a server assignment target (Step 272).

Subsequently, the message transfer unit 107 combines the received node ID with predetermined padding data and calculates a hash value based on SHA256-HASH (Step 273).

Subsequently, the message transfer unit 107 retrieves, from the obtained hash value, lower 32 bits (Step 274).

Then, the message transfer unit 107 searches for the retrieved lower 32 bits from the server assignment table and refers to a server ID assigned to it, to thereby determine the corresponding server ID (Step 275).

Although the example in which the messaging server 100 performs determination processing is shown in the figure, all or some (e.g., Steps 272 to 274) of the above-mentioned processes may be performed by the device 300. At this time, necessary information, for example, the server assignment table is transmitted from the messaging server 100 to the device 300.

Further, as in the first embodiment, the device ID is determined based on information (MAC address of Wireless LAN, IMEI of cellular phone, etc.) embedded in hardware of each device 300. Therefore, even if the user does not make any settings after the device 300 is purchased, the user can connect to the messaging server 100 and the notification server 200 that correspond to the device 300. The user can enjoy the environment capable of communicating with any other device 300 via them.

(Processing of Determining Network Address of Server)

In this embodiment, the plurality of messaging servers 100 and the plurality of notification servers 200 are provided, and hence it is necessary to also determine network addresses on TCP/IP, which correspond to the servers ID of the plurality of messaging servers 100 and the plurality of notification servers 200, in advance. Hereinafter, processing of determining the network address will be described.

Also regarding such processing of determining the network address, the following description is an example. It can be performed by both of the messaging server 100 and the device 300 but it may be performed by any way as long as it can be ensured that the both can obtain the same result.

Hereinafter, in order to determine the network address (IP address and port number), (1) example using a domain name system (DNS) and (2) example using a resolution table will be described. Although processing to be described in the following is also performed by the message transfer unit 107 of the messaging server 100, it may be performed by another module.

(1) Example Using DNS

The message transfer unit 107 of the messaging server 100 generates a host name based on a server number of the other messaging server 100 serving as a network address determination target. Then, the message transfer unit 107 acquires, based on the host name, the IP address using a DNS mechanism on the TCP/IP network.

For example, the host name of the messaging server 100 is generated as “ms15.server.com” and the host name of the notification server is generated as “ns1.server.com.”

Fixed values are used as their port numbers.

Then, the acquired IP address and port number are distributed into the device 300 and the other messaging server 100 and notification server 200.

(2) Example Using Resolution Table

The message transfer unit 107 creates a resolution table in which the IP address and the port number corresponding to the server number is defined, with respect to each of the messaging servers 100 and the notification servers 200. These resolution tables are distributed into the devices 300 and the other messaging servers 100 and notification servers 200.

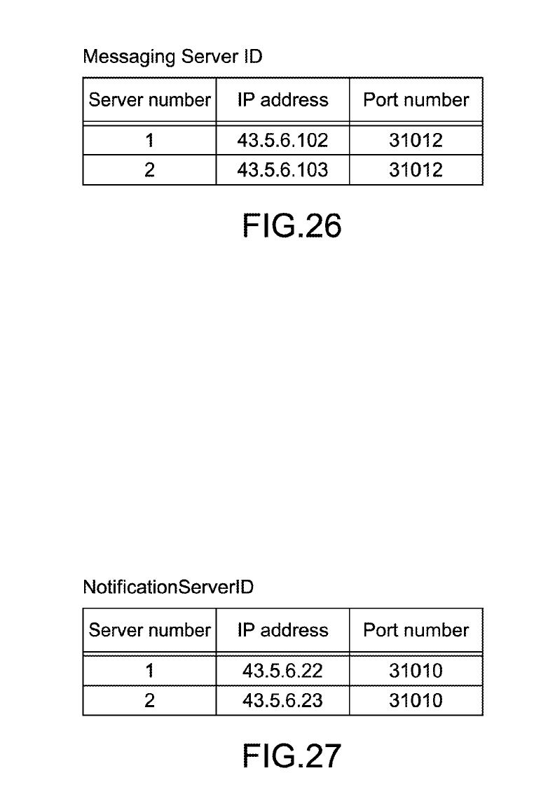

FIG. 26 is a view showing an example of the resolution table for the messaging server 100. FIG. 27 is a view showing an example of the resolution table for the notification server 200.

(Data Transmission Processing Example)

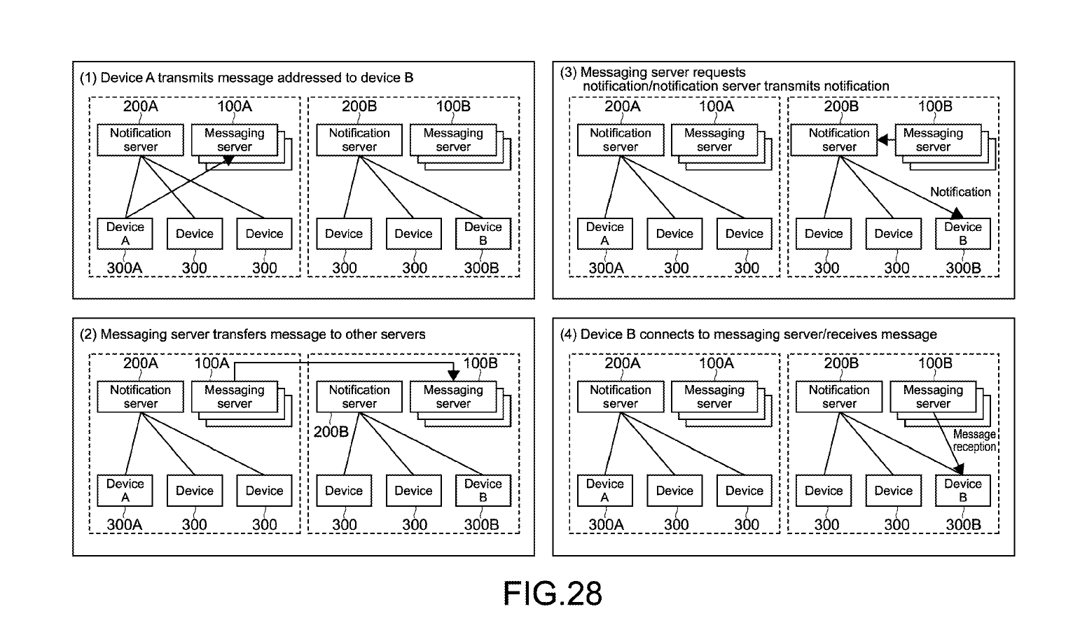

Next, data (message) transmission processing between the devices 300 in this embodiment will be described. FIG. 28 is a view schematically showing an outline of a flow of data transmission processing between the devices 300.

As shown in the figure, the device 300A serving as the message transmission source first transmits the message addressed to the device 300B to the messaging server 100A ((1) in figure).

Subsequently, if it is determined that it is a message that should be handled by the other messaging server 100B, the messaging server 100A that has received the message transfers the message to the messaging server 100B ((2) in figure).

Subsequently, the messaging server 100B to which the message has been transferred transmits, to the notification server 200B corresponding thereto, a notification request for requiring notification of the presence of the message to the device 300B from the device 300A. The notification server 200B that has received the notification request transmits the notification message to the device 300B corresponding thereto ((3) in figure).

Then, the device 300B that has received the notification message establishes a connection with the messaging server 100B corresponding thereto and receives the message from the device 300A ((4) in figure).

(Operations of Messaging Server)

Next, operations of the messaging server 100 in the above-mentioned transmission processing will be described. In the following description, operations of the messaging server 100A that first receives a message from the device 300 will be shown. Further, the other messaging server 100 will be referred to as the messaging server 100B for the sake of description.

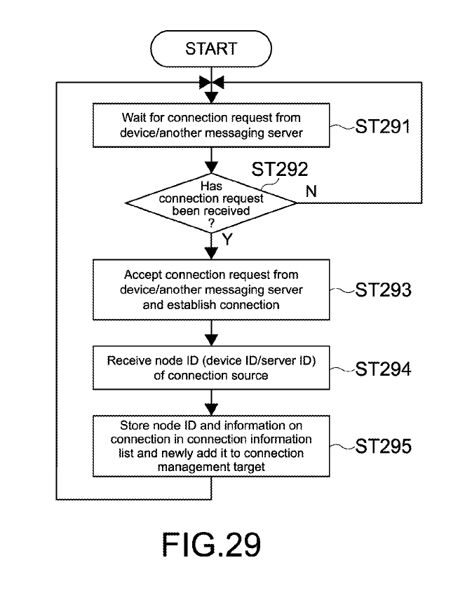

FIG. 29 is a flowchart showing a flow of operations of the connection processor 101 of the messaging server 100A.

As shown in the figure, the connection processor 101 first waits for a connection request from the device 300 or the other messaging server 100B (Step 291).

If a connection request from the device 300 or the other messaging server 100B is received (Yes in Step 292), the connection processor 101 accepts the connection request and establishes a connection (Step 293).

Subsequently, the connection processor 101 receives, from the device 300 or the other messaging server 100B serving as a connection source, its node ID (device ID, server ID) (Step 294).

Then, the connection processor 101 records the node ID and information on the connection (IP address and socket number) in the connection information list 104 and newly adds the device 300 or the other messaging server 100B to the connection management target (Step 295).

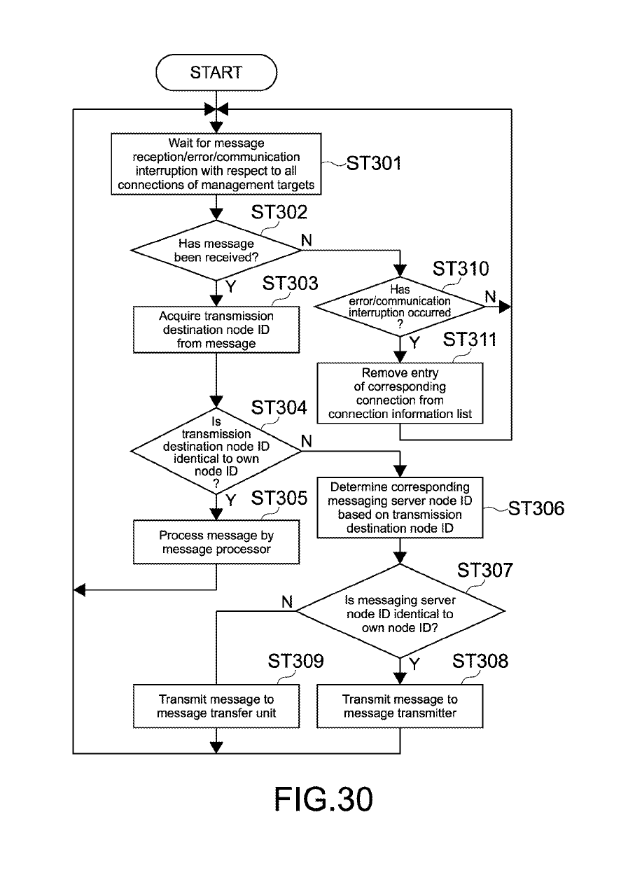

FIG. 30 is a flowchart showing a flow of operations of the connection management unit 102 of the messaging server 100A.

As shown in the figure, the connection management unit 102 first waits for any of message reception, an error, and a communication interruption with respect to all connections managed by the use of the connection information list 104 (Step 301).

Subsequently, the connection management unit 102 determines whether or not the message has been received (Step 302).

If it is determined that the message has been received (Yes), the connection management unit 102 acquires, from the message, the node ID set as a transmission destination thereof (Step 303).

Subsequently, the connection management unit 102 determines whether or not the acquired node ID is the node ID (server ID) of the messaging server 100A (Step 304).

It is determined that the node ID is the node ID of the messaging server 100A (Yes), the message processor 105 processes the message (Step 305).

If it is determined that the node ID of the transmission destination is not the node ID of the messaging server 100A (No), the connection management unit 102 refers to the server assignment table and determines, based on the node ID set as the transmission destination, the node ID of the messaging server corresponding thereto (Step 306).

Subsequently, the connection management unit 102 determines whether or not the node ID of the messaging server corresponding to the user ID is the node ID of the messaging server 100A (Step 307).

It is determined that the node ID of the corresponding messaging server is the node ID of the messaging server 100A (Yes), the connection management unit 102 passes the message to the message transmitter 106 (Step 308).

If it is determined that the node ID of the corresponding messaging server is the node ID of the other messaging server 100B (No), the connection management unit 102 passes the message to the message transfer unit 107 (Step 309).

In Step 302 described above, it is determined that the message is not received (No), the connection management unit 102 determines whether or not an error or a communication interruption has occurred with respect to any of connections of the management targets (Step 310).

If the error or the communication interruption has occurred (Yes), the connection management unit 102 excludes, from the connection information list 104, an entry associated with the connection in which the error or the communication has occurred (Step 311).

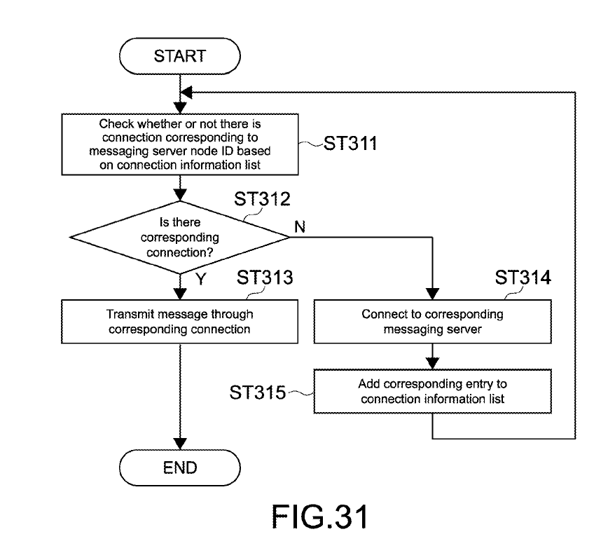

FIG. 31 is a flowchart showing a flow of operations of the message transfer unit 107 of the messaging server 100A.

As shown in the figure, the message transfer unit 107 checks, based on the connection information list 104, whether or not a connection corresponding to the node ID of the other messaging server 100B is present (it has already been connected to other messaging server 100B) (Step 311).

It is determined that the corresponding connection is present (Yes in Step 312), the message transfer unit 107 transfers a message to the connected other messaging server 100B (Step 313).

If it is determined that the corresponding connection is not present (No in Step 312), the message transfer unit 107 establishes a connection with the other messaging server 100B (Step 314).

Then, the message transfer unit 107 adds its entry to the connection information list 104 (Step 315), and then repeats processing after Step 311 described above.

[Conclusion]

As discussed above, in this embodiment, the plurality of messaging servers 100 and the plurality of notification servers 200 are provided and the messages are transferred between the messaging servers 100, and hence communication between a large number of devices 300 are supported.

### Third Embodiment

Next, a third embodiment of the present technology will be described. In this embodiment, portions having the same configurations and functions as those of the first and second embodiments will be denoted by the same reference symbols and descriptions thereof will be omitted.

[Network Configuration of System]

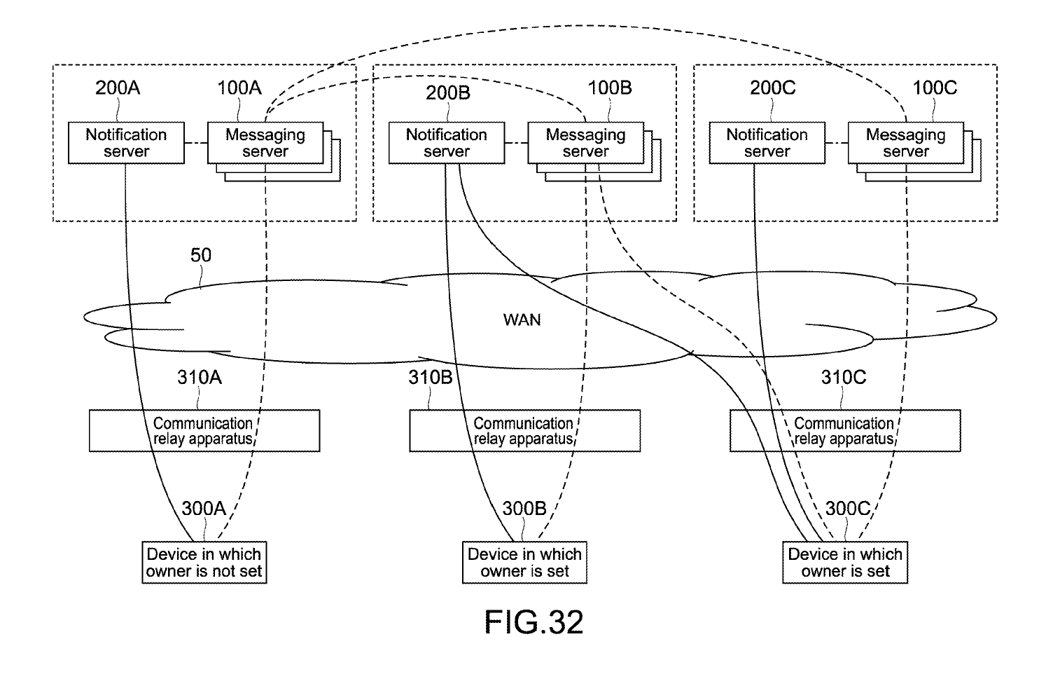

FIG. 32 is a diagram showing a network configuration of a system according to this embodiment.

In the above-mentioned first and second embodiments, it is assumed that the devices 300 are owned by different users. However, of course, the plurality of devices 300 may be owned by a plurality of users. In this case, it is considered that the number of times of communication between the devices 300 owned by the same user are larger than that of the others. Therefore, in this embodiment, a concept of an “owner” of each device 300 is introduced and, with respect to the device 300 in which a user ID for identifying an owner is set, the messaging server 100 and the notification server 200 that correspond thereto are determined based on the user ID.

As shown in the figure, also in this embodiment, as in the second embodiment, a plurality of messaging servers 100 and a plurality of notification servers 200 are present in the cloud system. For a device 300B and a device 300C of the devices 300, the same user is set as the owner. In this case, regarding the device 300B, the messaging server 100B and the notification server 200B are set as servers corresponding thereto. Further, regarding the device 300C, based on the server assignment table described in the second embodiment, a messaging server 100C and a notification server 200C are set as servers corresponding thereto. In addition, it has the same user ID as that of the device 300B, and hence the messaging server 100B and the notification server 200B are also set as each server corresponding thereto.

[Operations of System]

Next, operations of the messaging server 100, the notification server 200, and the devices 300 in the thus configured system will be described focusing on data (message) transmission processing between the devices 300.

(Processing of Determining Server to be Used Based on User ID)

As initial data, the messaging server 100 creates the messaging server assignment table and the notification server assignment table (hereinafter, referred to as server assignment table for user ID) based on the user ID in addition to the messaging server assignment table and the notification server assignment table (hereinafter, referred to as server assignment table for device ID) based on the device ID as described above. These tables are distributed into each of the devices 300, the messaging servers 100, and the notification servers 200 in advance. A method of creating the server assignment table for the user ID is the same as described in the second embodiment except for that the device ID is replaced by the user ID.

The server assignment table for the device ID and the server assignment table for the user ID may be created by the device 300.

For creating the tables, a group of servers assigned based on the device ID and a group of servers assigned based on the user ID are individually prepared.

Further, each device 300 includes a means for recording the user ID (owner ID). An initial state of each device 300, NULL is set.

As in the second embodiment, the device 300 in which the user ID has not been set yet connects to the messaging server 100 and the notification server 200 that are determined by the device ID.

On the other hand, the device 300 in which the user ID has been already set can be connected to all of the messaging server 100 and the notification server 200 that are determined by each of the device ID and the user ID. The device 300 serving to transmit a message typically connects to the messaging server 100 determined by its user ID. If the user ID is set as the destination of the message, the device 300 serving to receive a message is connected to the messaging server 100 corresponding thereto. If not, it connects to the messaging server 100 corresponding to the device ID.

If each device 300 knows both of the device ID and the user ID of the device 300 serving as the message transmission destination, each device 300 sets the both as the destination of the message and transmits the message.

If each device 300 knows only the device ID of the device 300 serving as the message transmission destination, the device ID is set as the destination of the message and transmits the message.

(Operations of Messaging Server)

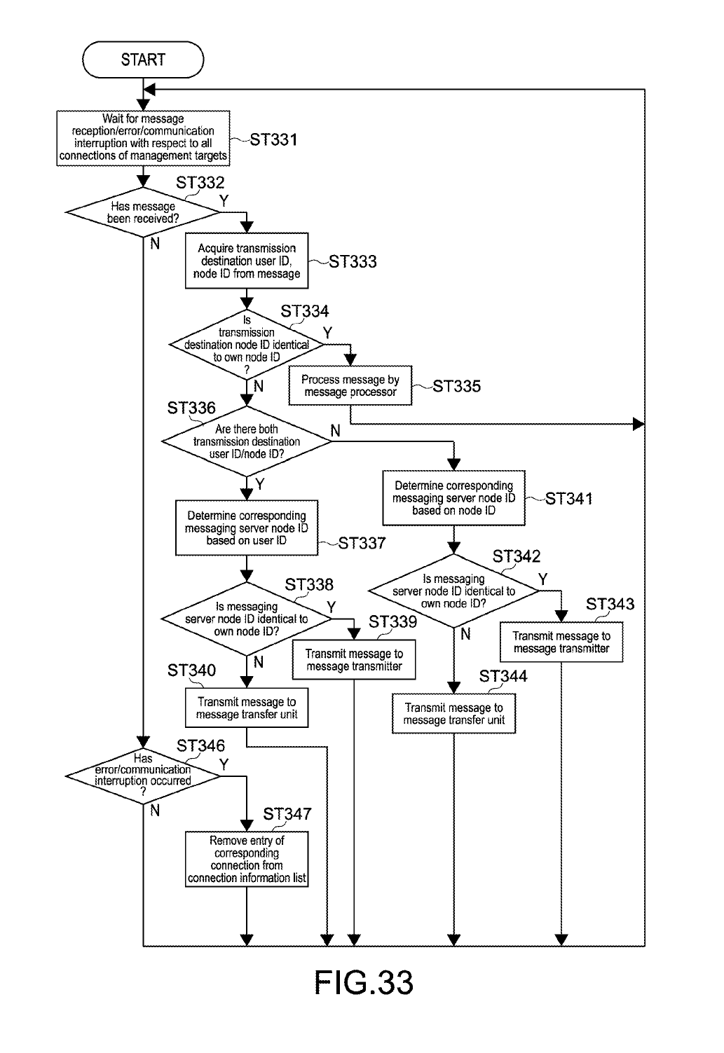

Next, operations of the messaging server 100 in the above-mentioned message transmission processing will be described. FIG. 33 is a flowchart showing a flow of these operations. In the following description, operations of the messaging server 100A that first receives a message from the device 300 will be shown. Further, the other messaging server 100 will be referred to as the messaging server 100B for the sake of description.

As shown in the figure, the connection management unit 102 of the messaging server 100A first waits for any of message reception, an error, and a communication interruption with respect to all connections managed by the use of the connection information list 104 (Step 331).

Subsequently, the connection management unit 102 determines whether or not the message has been received (Step 332).

If it is determined that the message has been received (Yes), the connection management unit 102 acquires, from the message, the user ID and the node ID set as the transmission destination thereof (Step 333).

Subsequently, the connection management unit 102 determines whether or not the acquired node ID is the node ID (server ID) of the messaging server 100A (Step 334).

It is determined that the node ID is the node ID of the messaging server 100A (Yes), the message processor 105 processes the message (Step 335).

If it is determined that the node ID of the transmission destination is not the node ID of the messaging server 100A (No), the connection management unit 102 determines whether or not both of the user ID and the node ID are present as the transmission destination (Step 336).

It is determined that both of the user ID and the node ID are present as the transmission destination (Yes), the connection management unit 102 refers to the server assignment table for the user ID and determines, based on the user ID set as the transmission destination, the node ID of the messaging server corresponding thereto (Step 337).

Subsequently, the connection management unit 102 determines whether or not the node ID of the messaging server corresponding to the user ID is the node ID of the messaging server 100A (Step 338).

If it is determined that the node ID of the corresponding messaging server is the node ID of the messaging server 100A (Yes), the connection management unit 102 passes the message to the message transmitter 106 (Step 339).

If it is determined that the node ID of the corresponding messaging server is the node ID of the other messaging server 100B (No), the connection management unit 102 passes the message to the message transfer unit 107 (Step 340).

In Step 336 described above, it is determined that both of the user ID and the node ID are not present as the transmission destination, that is, only the node ID is present (No), the connection management unit 102 refers to the server assignment table for the device ID and determines, based on the node ID set as the transmission destination (device ID), the node ID of the messaging server corresponding thereto (Step 341).

Subsequently, the connection management unit 102 determines whether or not the node ID of the messaging server corresponding to the node ID is the node ID of the messaging server 100A (Step 342).

It is determined that the node ID of the corresponding messaging server is the node ID of the messaging server 100A (Yes), the connection management unit 102 passes the message to the message transmitter 106 (Step 343).

If it is determined that the node ID of the corresponding messaging server is the node ID of the other messaging server 100B (No), the connection management unit 102 passes the message to the message transfer unit 107 (Step 344).

In Step 332 described above, if it is determined that the message is not received (No), the connection management unit 102 determines whether or not an error or a communication interruption has occurred with respect to any of connections of the management targets (Step 346).

If the error or the communication interruption has occurred (Yes), the connection management unit 102 excludes, from the connection information list 104, an entry associated with the connection in which the error or the communication has occurred (Step 347).

[Conclusion]

As discussed above, according to this embodiment, the device 300 in which the same user ID has been set is connected to the same messaging server 100 and notification server 200 as long as this user ID is set as the destination of the message. Therefore, the number of times of communication between the messaging servers 100 is reduced and the load on the cloud system is reduced.

### Modified Example

The present technology is not limited only to the above-mentioned embodiments and may be variously changed without departing the gist of the present technology.

In each of the above-mentioned embodiments, regarding the communication from the messaging server 100 to the notification server 200, the connection is established or released every time the communication is performed. However, the connection may be maintained for a predetermined period of time.

In each of the above-mentioned embodiments, in the case where the plurality of notification means are available, the messaging server 100 tries them in order. However, in the case where a plurality of communication means are available, the messaging server 100 may try them according to a priority order or may perform notification processes in parallel by the plurality of notification means in order to improve the response.

In each of the above-mentioned embodiments, each device 300 is provided with the notification means setting unit 301 for setting the notification means. However, the notification means setting unit 301 may be omitted in the case where each device 300 uses only a particular notification means.

In each of the above-mentioned embodiments, each device 300 is provided with the notification server notification receiver 302 and the direct notification receiver 303 depending on whether or not to use the notification server 200. However, either one of them may be operated or these may be operable at the same time.

In each of the above-mentioned embodiments, the connection used by the message receiver 304 of each device 300 is maintained for a predetermined period of time once the connection is established. However, the message receiver 304 may be connected to the server in case of necessity every time the connection is established. Further, in each of the above-mentioned embodiments, the connection used by the message transmitter 305 of each device 300 may be established or released every time. Once the connection is established, it may be maintained for a predetermined period of time.

In each of the above-mentioned embodiments, the message receiver 304 and the message transmitter 305 of each device 300 are shown as individual modules. However, the connection may be shared by the both.

In each of the above-mentioned embodiments, each device 300 maintains the connection with the notification server 200 also while being connected to the messaging server 100. However, each device 300 may be disconnected from the notification server 200 and re-connected to the notification server 200 when the connection with the messaging server 100 is released.

In each of the above-mentioned embodiments, the messages are used in all exchanges between the devices 300 via the messaging server 100. However, for applications of each device 300, based on this message mechanism, a remote procedure call (RPC) mechanism and a stream communication mechanism, and further, a communication mechanism such as HTTP emulation may be provided.

In the above-mentioned embodiment, the messaging server 100 and the notification server 200 are shown as physically different servers. However, the difference between them is caused by settings of the buffer size for the connection with each device 300 and how to handle it, and hence the following mode can provide the same effects instead of the mode of being operated on the physically different servers.

(1) To Operate both a notification server process and a messaging server process on the single server machine.
(2) To Operate a single server process having a notification server function and a messaging server function on a single server machine (to switch between connection mode corresponding to notification server and connection mode corresponding to messaging server depending on communication situation with device 300).

[Others]

The present technology may also take the following configurations.

[1] An information processing apparatus, including:

a communication unit that is capable of, in case of necessity, connecting to any of a first device, a second device, and a constantly connected server, which is constantly connected to the second device via a network, via the network for communication; and

a control unit that is capable of controlling the communication unit to receive, from the first device, data addressed to the second device, to transmit, to the constantly connected server, notification request information for requesting to transmit a notification message for notifying presence of the data to the second device, and to transmit the data to the second device in response to a request from the second device that receives the notification message.

[2] The information processing apparatus according to [1], further including

a storage unit, in which

the second device communicates with the information processing apparatus and the constantly connected server via a communication relay apparatus, and

the control unit
controls, if the communication relay apparatus is set to transfer communication from the information processing apparatus to the second device, the storage unit to store information on the transfer setting, and
controls the communication unit to directly transmit the notification message to the second device using the stored information, instead of transmitting the notification request information or in addition to transmitting the notification request information.
   [3] The information processing apparatus according to [1] or [2], in which

the control unit controls, if a global IP address is assigned to the second device, the communication unit to directly transmit the notification message to the second device instead of transmitting the notification request information or in addition to transmitting the notification request information.

[4] The information processing apparatus according to any one of [1] to [3], in which

the information processing apparatus and the constantly connected server include a plurality of information processing apparatuses and a plurality of constantly connected servers, respectively,

the first device and the second device are each set to correspond to one of the information processing apparatuses and one of the constantly connected servers using device identification information for uniquely identifying the first device, the second device, the plurality of information processing apparatuses, and the plurality of constantly connected servers such that each of the first device and the second device communicates with one of the information processing apparatuses and one of the constantly connected servers; and

the control unit controls, if it is, based on the device identification information, determined that the second device corresponds to another information processing apparatus, the communication unit to transfer the data to the other information processing apparatus.

[5] The information processing apparatus according to [4], further including

a storage unit, in which

the control unit
creates a table in which a corresponding relationship between a value based on a hash value obtained based on a predetermined hash function based on device identification information of each of the first device and the second device and identification information of each of the plurality of information processing apparatuses is defined,
control the storage unit to store the created table, and
determine, based on the stored table, another information processing apparatus corresponding to the second device.
   [6] The information processing apparatus according to [5], in which

the control unit creates, if user identification information for uniquely identifying a user who owns each of the first device and the second device is set in each of the first device and the second device, the table using the user identification information instead of the device identification information.

### DESCRIPTION OF SYMBOLS

11, 31 CPU
12, 32 ROM
13, 33 RAM
18, 38 storage unit
19, 39 communication unit
50 WAN
100 (100A, 100B, 100C) messaging server
101 connection processor
102 connection management unit
103 notification means list
104 connection information list
105 message processor
106 message transmitter
107 message transfer unit
200 (200A, 200B, 200C) notification server
201 connection processor
202 connection management unit
203 connection information list
300 (300A, 300B, 300C) device
301 notification means setting unit
302 notification server notification receiver
303 direct notification receiver
304 message receiver
305 message transmitter
306 message processor
310 (310A, 310B) communication relay apparatus

1. An information processing apparatus, comprising:
a communication unit that is capable of, in case of necessity, connecting to any of a first device, a second device, and a constantly connected server, which is constantly connected to the second device via a network, via the network for communication; and
a control unit that is capable of controlling the communication unit to receive, from the first device, data addressed to the second device, to transmit, to the constantly connected server, notification request information for requesting to transmit a notification message for notifying presence of the data to the second device, and to transmit the data to the second device in response to a request from the second device that receives the notification message.

2. The information processing apparatus according to claim 1, further comprising
a storage unit, wherein
the second device communicates with the information processing apparatus and the constantly connected server via a communication relay apparatus, and
the control unit
controls, if the communication relay apparatus is set to transfer communication from the information processing apparatus to the second device, the storage unit to store information on the transfer setting, and
controls the communication unit to directly transmit the notification message to the second device using the stored information, instead of transmitting the notification request information or in addition to transmitting the notification request information.

3. The information processing apparatus according to claim 1, wherein
the control unit controls, if a global IP address is assigned to the second device, the communication unit to directly transmit the notification message to the second device instead of transmitting the notification request information or in addition to transmitting the notification request information.

4. The information processing apparatus according to claim 1, wherein
the information processing apparatus and the constantly connected server include a plurality of information processing apparatuses and a plurality of constantly connected servers, respectively,
the first device and the second device are each set to correspond to one of the information processing apparatuses and one of the constantly connected servers using device identification information for uniquely identifying the first device, the second device, the plurality of information processing apparatuses, and the plurality of constantly connected servers such that each of the first device and the second device communicates with one of the information processing apparatuses and one of the constantly connected servers; and
the control unit controls, if it is, based on the device identification information, determined that the second device corresponds to another information processing apparatus, the communication unit to transfer the data to the other information processing apparatus.

5. The information processing apparatus according to claim 4, further comprising
a storage unit, wherein
the control unit
creates a table in which a corresponding relationship between a value based on a hash value obtained based on a predetermined hash function based on device identification information of each of the first device and the second device and identification information of each of the plurality of information processing apparatuses is defined,
control the storage unit to store the created table, and
determine, based on the stored table, another information processing apparatus corresponding to the second device.

6. The information processing apparatus according to claim 5, wherein
the control unit creates, if user identification information for uniquely identifying a user who owns each of the first device and the second device is set in each of the first device and the second device, the table using the user identification information instead of the device identification information.

7. An information processing apparatus, comprising:
a communication unit that is capable of constantly connecting to a first device and a second device via a network for communication, and capable of, in case of necessity, connecting to a mediation server that mediates transmission and reception of data between the first device and the second device via the network for communication; and
a control unit that is capable of controlling the communication unit to receive, when data addressed to the second device that is transmitted from the first device is received by the mediation server, notification request information for requesting to transmit a notification message for notifying presence of the data to the second device, from the mediation server, and to transmit, based on the notification request information, the notification message to the second device.

8. An information processing apparatus, comprising:
a communication unit that is capable of, in case of necessity, connecting to a first server via a network, and capable of constantly connecting to a second server via the network for communication; and
a control unit that is capable of controlling the communication unit to receive, from the second server, a notification message for notifying presence of data transmitted from another information processing apparatus and receive, based on the received notification message, the data from the first server.

9. An information processing method, comprising:
establishing a connection with a first device via a network and receiving data addressed to a second device from the first device;
transmitting notification request information for requesting to transmit a notification message for notifying presence of the data to the second device, to a server constantly connected to the second device; and
establishing a connection in response to a request from the second device that receives the notification message and transmitting the data to the second device.

10. A program that causes an information processing apparatus to execute the steps of:
establishing a connection with a first device via a network and receiving data addressed to a second device from the first device;
transmitting notification request information for requesting to transmit a notification message for notifying presence of the data to the second device, to a constantly connected server constantly connected to the second device; and
establishing a connection with the second device in response to a request from the second device that receives the notification message and transmitting the data to the second device.
